(19) United States
(12) Patent Application Publication
(10) Pub. No.: US 2025/0307525 A1
(43) Pub. Date: Oct. 2, 2025

(54) SEARCH DOMAIN-BASED KEYWORD GENERATION AND USER INTERFACE FILTERING AND NAVIGATION

(71) Applicant: Optum Services (Ireland) Limited, Dublin (IE)

(72) Inventors: Colum Foley, Dublin (IE); Paul Andrew Ferguson, Dublin (IE)

(21) Appl. No.: 18/618,529

(22) Filed: Mar. 27, 2024

(51) Int. Cl. G06F 40/103; G06F 40/279

(52) U.S. Cl. CPC G06F 40/103; G06F 40/279

(57) ABSTRACT

Various embodiments of the present disclosure provide computer processing and optimization techniques for improving keyword generation, real time keyword filtering, and user interface navigation. The techniques may include identifying an interaction code from an interaction data object and receiving a modified candidate keywords list for the interaction code where the modified candidate keywords list is generated by iteratively appending one or more interaction code descriptions of an interaction corpus corresponding to the interaction code to generate a candidate keywords list, and generating the modified candidate keywords list by pruning one or more predefined terms of the domain-specific term corpus from the candidate keywords list. The techniques may include generating an interaction-specific keywords list based on a comparison between the modified candidate keywords list and an interaction description of the interaction data object and initiating the performance of a prediction-based action based on the interaction-specific keywords list.

### BACKGROUND

Various embodiments of the present disclosure address technical challenges related to keyword identification generally and, more specifically, to techniques for generating and matching keywords within a search domain. Traditionally, automated keyword generation and matching techniques rely on large computational footprints and generate or identify keywords that may be unidentifiable to users within a particular search domain. The keywords output by such techniques may be disruptive to the workflow of users and counteract the perceived benefits of automated keyword searching and filtering within a user interface. For example, keywords may be generated for a user to help a user navigate a document in order to provide a focused review of the document with respect to an evaluation task. At times, traditional techniques may surface keywords that may be related to the evaluation task, but not identifiable to a user, leading to confusion rather than facilitating a quicker, more efficient review of the document. In other cases, keywords may be generated slowly or be too specific to help navigate withing a document, such that they ultimately hinder efficiency rather than help. Significant technical challenges arise when generating and identifying relevant and expected keywords for a large search space in an efficient manner.

Various embodiments of the present disclosure make important contributions to traditional keyword detection techniques by addressing each of these technical challenges.

### BRIEF SUMMARY

Various embodiments of the present disclosure provide improved keyword generation techniques for optimizing prediction-based actions by tailoring keywords to a particular search domain. Using some of the techniques of the present disclosure, keywords lists may be generated that are tailored to a particular search domain by extracting the terminology directly from an interaction corpus for the domain. For instance, various search domains may include historical text, dictionaries, and/or other standardized documents within the domain. Some of the techniques of the present disclosure leverage this interaction corpus to generate keywords lists that are recognizable to a user performing a task within the domain. In some examples, the keywords lists may be mapped to codes that are specific to a particular domain. During an online task, a code may be identified from the text of a document that is being evaluated and mapped to a predetermined keywords list to surface keywords that are relevant to the document, recognizable within the search domain, and dynamically retrieved in real time. By doing so, a keywords list may be leveraged, in real time, to navigate a document using predictive insights that are recognizable and appreciated by a user. This, in turn, leads to improved document navigation and filtering techniques within a user interface.

In some embodiments, a computer-implemented method comprises identifying, by one or more processors, an interaction code from an interaction data object; receiving, by the one or more processors, a modified candidate keywords list for the interaction code, wherein the modified candidate keywords list is generated by: iteratively appending one or more interaction code descriptions of an interaction corpus corresponding to the interaction code to generate a candidate keywords list, and generating, using a domain-specific term corpus, the modified candidate keywords list by pruning one or more predefined terms of the domain-specific term corpus from the candidate keywords list; generating, by the one or more processors, an interaction-specific keywords list based on a comparison between the modified candidate keywords list and an interaction description of the interaction data object; and initiating, by the one or more processors, the performance of a prediction-based action based on the interaction-specific keywords list.

In some embodiments, a computing system comprises memory and one or more processors that are communicatively coupled to the memory, the one or more processors are configured to: identify, by one or more processors, an interaction code from an interaction data object; receive, by the one or more processors, a modified candidate keywords list for the interaction code, wherein the modified candidate keywords list is generated by: iteratively appending one or more interaction code descriptions of an interaction corpus corresponding to the interaction code to generate a candidate keywords list, and generating, using a domain-specific term corpus, the modified candidate keywords list by pruning one or more predefined terms of the domain-specific term corpus from the candidate keywords list; generate, by the one or more processors, an interaction-specific keywords list based on a comparison between the modified candidate keywords list and an interaction description of the interaction data object; and initiate, by the one or more processors, the performance of a prediction-based action based on the interaction-specific keywords list.

In some embodiments, one or more non-transitory computer-readable storage media includes instructions that, when executed by one or more processors, cause the one or more processors to identify, by one or more processors, an interaction code from an interaction data object; receive, by the one or more processors, a modified candidate keywords list for the interaction code, wherein the modified candidate keywords list is generated by: iteratively appending one or more interaction code descriptions of an interaction corpus corresponding to the interaction code to generate a candidate keywords list, and generating, using a domain-specific term corpus, the modified candidate keywords list by pruning one or more predefined terms of the domain-specific term corpus from the candidate keywords list; generate, by the one or more processors, an interaction-specific keywords list based on a comparison between the modified candidate keywords list and an interaction description of the interaction data object; and initiate, by the one or more processors, the performance of a prediction-based action based on the interaction-specific keywords list.

### BRIEF DESCRIPTION OF DRAWINGS

FIG. 1 provides an example overview of an architecture in accordance with some embodiments of the present disclosure.

FIG. 2A provides an example computing entity in accordance with some embodiments of the present disclosure.

FIG. 2B provides an example client computing entity in accordance with some embodiments of the present disclosure.

FIG. 3 is a dataflow diagram showing example data structures and modules for generating a comprehensive search keyword list in accordance with some embodiments discussed herein.

FIG. 4 is a dataflow diagram showing example data structures for initiating a prediction-based action in accordance with some embodiments discussed herein.

FIG. 5 is an example asynchronous, multi-stage pipeline for tailoring and surfacing keywords within a search domain in accordance with some embodiments discussed herein.

FIG. 6 is a flowchart showing an example process for asynchronously generating modified candidate keywords lists that are tailored to a search domain in accordance with some embodiments discussed herein.

FIG. 7 is a flowchart showing an example process for retrieving a modified candidate keywords list to generate an interaction-specific keywords list and initiate a prediction-based action based thereon in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

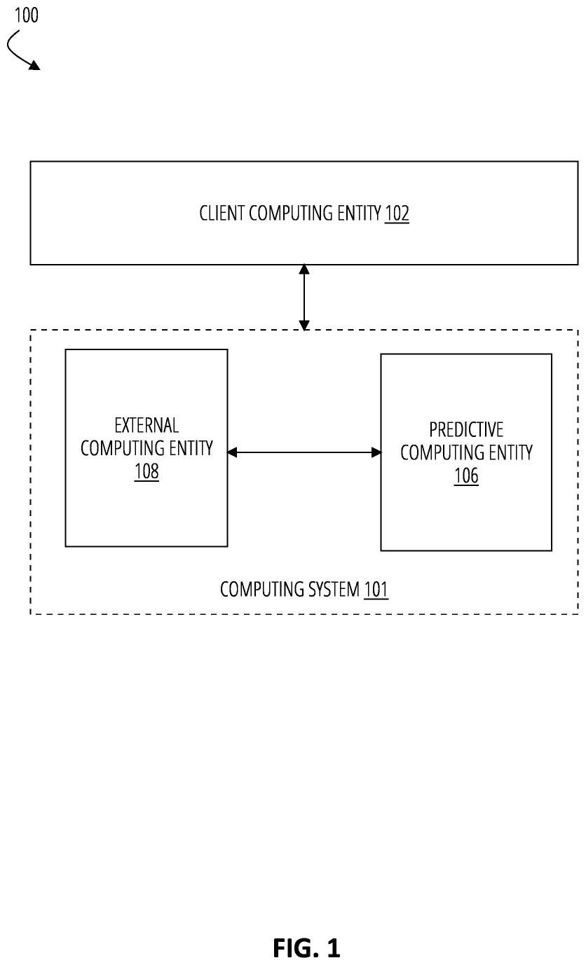

FIG. 1 provides an example overview of an architecture 100 in accordance with some embodiments of the present disclosure. The architecture 100 includes a computing system 101 configured to generate a plurality of predictive measures (e.g., in response to request from client computing entities 102), process the predictive measures to generate impact predictions for a plurality of prediction-based actions, and facilitate improved user interfaces (and/or information for the user interface) based on the impact predictions for the client computing entities 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, a multi-stage pipeline may include complementary processes for optimizing keyword generation techniques described herein. By doing so, one or more prediction-based actions tailored to a particular search domain may be initiated based on a generated keywords list. By doing so, the techniques of the present disclosure may lead to improved document navigation and filtering techniques within a user interface.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive data objects from client computing entities 102, process the requests to generate predictions and/or provide user interface data based on the generated predictions, and provide the generated predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or prediction operations of the present disclosure. In some examples, the external computing entities 108 may be configured to train, implement, use, update, and evaluate machine learning models in accordance with one or more training and/or prediction operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., machine learning, computer processing, data matching techniques, user interface navigation and keyword filtering techniques, and/or the like) described herein. The external computing entities 108, for example, may include and/or be associated with one or more entities that may be configured to receive, transmit, store, manage, and/or facilitate datasets, such as a dataset including modified keywords lists, interaction data objects, one or more portions of an interaction corpus, secondary interaction corpus, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more prediction steps/operations of the present disclosure. In some examples, feedback (e.g., evaluation data, ground truth data, etc.) from the use the of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

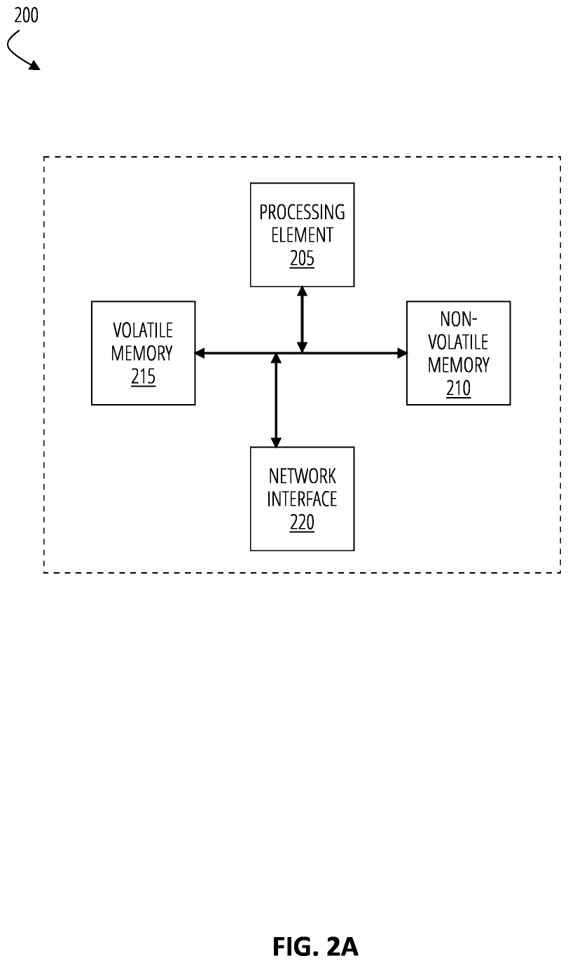

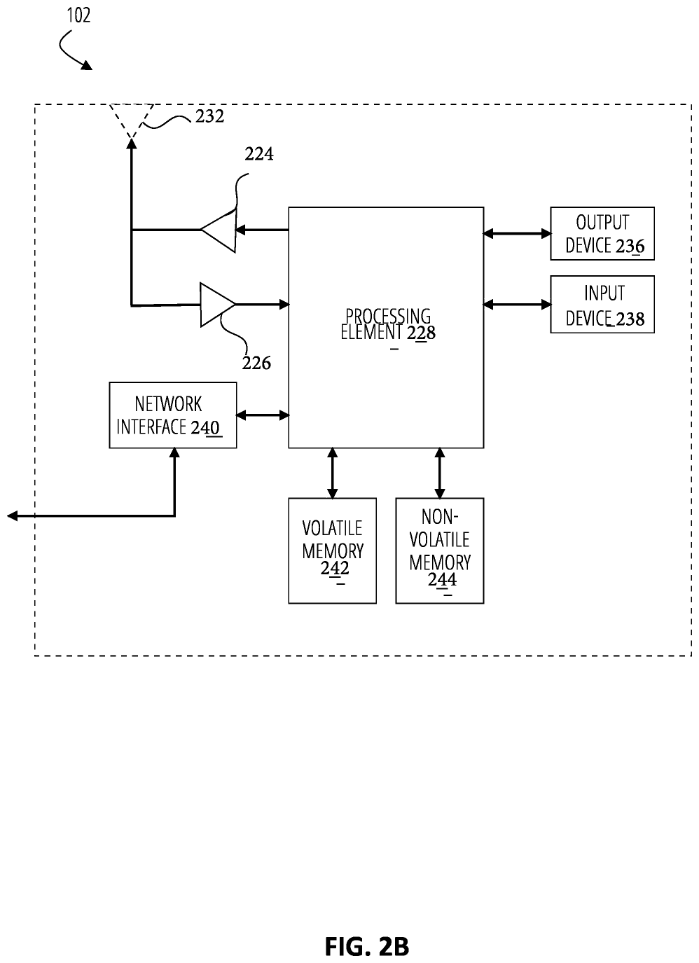

FIG. 2A provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning model(s) described herein, and subsequently provide the trained machine learning model(s) (e.g., optimized weights, code sets, etc.) to the first computing entity over a network.

As shown in FIG. 2A, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

FIG. 2B provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 2B, the client computing entity 102 may include an antenna 232, a transmitter 224 (e.g., radio), a receiver 226 (e.g., radio), and a processing element 228 (e.g., CPLDs, microprocessors, multi-core processors, coprocessing entities, ASIPs, microcontrollers, and/or controllers) that provides signals to and receives signals from the transmitter 224 and receiver 226, correspondingly.

The signals provided to and received from the transmitter 224 and the receiver 226, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 240.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 236 (e.g., display, speaker, tactile instrument, etc.) coupled to a processing element 228) and/or a user input interface (coupled to a processing element 228). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 238 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#,*), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 242 and/or non-volatile memory 244, which may be embedded and/or may be removable. For example, the non-volatile memory 244 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 242 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 240, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an Al computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “interaction data object” refers to a data entity that describes a recorded interaction. An interaction data object may include one or more interaction codes that describe one or more characteristics of the recorded interaction. Additionally, or alternatively, an interaction data object may include contextual data associated with the one or more interaction codes. For example, an interaction data object may include an interaction description corresponding to the recorded interaction.

An interaction data object may be associated with a different type of interaction based on a prediction domain. As one example, for a clinical domain, an interaction data object may describe a medical record for a medical visit, medical claim, and/or the like.

In some embodiments, the term “interaction code” refers a data entity that describes a predictive classification for a prediction domain. An interaction code may include a predefined alpha-numeric identifier that identifies one or more observed characteristics within a prediction domain. In some examples, an interaction code may correspond to an event and/or procedure for an entity within the prediction domain. By way of example, and continuing with the clinical prediction domain, the event may include a diagnosis for a disease corresponding to the interaction code. In another example, the event may include a procedure corresponding to treating a disease. For instance, an interaction code may include one or more codes such as ICD-10-CM codes, Current Procedural Terminology (CPT) codes, Healthcare Common Procedure Codding System (HCPCS) codes, and/or the like.

In some embodiments, the term “interaction description” refers to semantic content that describes a meaning, purpose, and/or context of an interaction. An interaction description, for example, may include structured and/or natural language text included within and/or associated with an interaction data object that describes an interaction. The interaction description, for example, may include one or more interaction codes, one or more contextual characteristics associated with the one or more interaction codes and/or an interaction, and/or the like.

As an example, in a clinical prediction domain, an interaction description may include clinically relevant information associated with a clinical visit. For instance, an interaction description may be a standardized and/or non-standardized description associated with a particular clinical visit, a procedure performed during the clinical visit, diagnosis provided during the clinical visit, and/or the like. In some examples, an interaction description may be a description associated with a medical claim and may be recorded by one or more healthcare professionals.

In some embodiments, an interaction description may be tokenized. For example, an interaction description may include, be made of, be used to identify, and/or the like, one or more description tokens.

In some embodiments, the term “description token” refers to a data entity that describes a set of one or more characters within an interaction description. For example, a description token may describe one or more characters, a single word, a set of words, and/or the like. In some examples, a variety of text tokenization methods, operations, functions, and/or techniques may be utilized to separate/identify terms within an interaction description that may be identified as description tokens. In some examples, a description token may be used to generate an embedding. By way of example, a description token may include a word-level token used to generate word-level embeddings of an interaction description.

In some embodiments, the term “interaction code description” refers to semantic content such as a structured and/or natural language sequence of text that describes a meaning, purpose, and/or context of an interaction code. An interaction code description, for example, may include structured and/or natural language text corresponding to an interaction code. The structured and/or natural language text may include a manual, automated, and/or semi-automated text annotation provided for an interaction code. For example, an interaction code description may include one or more segments of text from one or more interaction corpuses, dictionaries, and/or the like that define one or more of a plurality of interaction codes. In this manner, an interaction code description may be used to identify contextual information, such as medically relevant information in a clinical context, relating to an event recorded by an interaction code within an interaction data object.

By way of example, in a clinical prediction domain, an interaction code description may include clinically relevant information corresponding to an interaction code. For instance, an interaction code description may be a standardized and/or non-standardized description associated with a particular medical code, such as anICD-10 code, CPT code, and/or the like, that describes relevant clinical information, such as the name, uses, symptoms, history, methods, abnormal findings, and/or the like, of a corresponding diagnosis, procedure, and/or the like. In such a case, the interaction code description may be accessed from an interaction corpus, such as the Unified Medical Language System (UMLS) database, an Extended Evaluation and Management (E&M) checklist, and/or the like.

In some embodiments, the term “interaction corpus” refers to a collection or repository of information relevant to one or more interaction codes. For example, an interaction corpus may be or include a metathesaurus, semantic network, lexicon, and/or the like. In some examples, an interaction corpus includes a plurality of interaction codes, interaction code descriptions, and/or other contextual supplementary information that may be related to an interaction code. In some examples, an interaction corpus may be leveraged to generate one or more keywords for an interaction code.

For example, in a clinical context, an interaction corpus may include a plurality of textual descriptions associated with medical codes (e.g., billable diagnosis and/or procedural codes, etc.) of a medical record (e.g., interaction data object). By way of example, the interaction corpus may include the UMLS database, an E&M checklist, and/or any other source of text to describe a medical code.

In some embodiments, an interaction corpus defines a set of relationships between a plurality of interaction codes and/or interaction code descriptions. For example, an interaction corpus may define a mapping between an interaction code and an interaction code description. For instance, the interaction corpus may include a one-to-one mapping, one-to-many mapping, many-to-many mapping, and/or the like, between an interaction code and an interaction code description.

In some embodiments, an interaction corpus may define a hierarchical, graph-based, and/or other complex set of relationships between one or more interaction codes. For example, an interaction corpus may contain a hierarchical structure that defines root nodes, leaf nodes, and dependency relationships between a plurality of parent-child nodes. For instance, an interaction corpus may define a plurality of nodes corresponding to a plurality of interaction code descriptions where each node may have a parent node and/or a child node and each node may be a parent node or child node with respect to another node. In some examples, each child and parent node may correspond to different levels of the hierarchical structure.

In some embodiments, an interaction corpus may have properties that correspond to using various n-gram tokenization methods. In some examples, an interaction corpus may not include well-defined documentation requirements such that the interaction corpus contains low quality or unreliably structured interaction code descriptions. In such a case, unigrams may be used during tokenization operations applied to one or more interaction code descriptions. In some examples, an interaction corpus may include well-defined documentation requirements such that the interaction corpus contains high quality or reliably structured interaction code descriptions. In such a case, it may be preferred that greater n-gram (e.g., bigrams) are used during tokenization operations applied to the interaction code descriptions.

In some embodiments, the term “secondary interaction corpus” refers to a collection or repository of information relevant to one or more interaction codes that may supplement and/or supersede an interaction corpus for one or more interaction codes. In some examples, a secondary interaction corpus may be used to expand and/or replace the information provided by the interaction corpus. In some examples, one or more different secondary interaction corpuses may be leveraged to augment and/or replace keywords for one or more interaction codes associated therewith. By way of example, a secondary interaction corpus, for a subset of interaction codes, may include one or more E&M checklists that respectively correspond to the subset of interaction codes.

In some embodiments, a secondary interaction corpus may be tailored to an evaluation, search, and/or other task for an interaction data object. For example, in some scenarios, an interaction data object may be reviewed to ensure that one or more criteria are satisfied for an interaction code. In some examples, the one or more criteria may be illustrated by an E&M checklist, such that keywords generated from the E&M checklist may direct a user through the interaction data object in accordance with the E&M checklist. In this way, a different set of keywords may be generated from number of data sources to curate keywords that are both predictive and recognizable to a user.

In some embodiments, the term “candidate keywords list” refers to a data structure that describes a set of one or more words (e.g., word-level tokens, etc.) that are relevant to an interaction code. For example, a keyword list may be generated for a prediction domain based on a plurality of candidate keyword lists respectively generated for each of a plurality of interaction codes defined for the prediction domain. In some examples, each of the one or more terms of a candidate keywords list may be a candidate for inclusion in a keywords list for a particular interaction code. For example, a candidate keywords list may include a superset of tokens from which a subset of keywords may be selected. In some examples, a candidate keywords list may be modified, expanded, pruned, and/or generally manipulated. In some examples, the one or more terms of a candidate keywords list may be a token or associated with a token.

In some embodiments, a candidate keywords list is generated from one or more interaction code descriptions of an interaction corpus and/or secondary interaction corpus. For example, a candidate keywords list may include an interaction code description identified by matching an interaction code of an interaction data object to an interaction code description of an interaction corpus. In some examples, the candidate keywords list may include the interaction code description for the interaction code and/or one or more related interaction code descriptions from the interaction corpus. For instance, the interaction code description may include an initial candidate keywords list and one or more related interaction code descriptions may be iteratively identified and appended to the initial candidate keywords list to generate a candidate keywords list.

For example, in the event that an interaction corpus defines a hierarchical structure, a candidate keywords list may include one or more related interaction code descriptions for one or more parent and/or child nodes to an interaction code. For instance, the one or more related interaction codes may correspond to one or more parent nodes to a particular interaction code. As an example, a candidate keywords list may include an interaction code description as well as its nth level parents. In this manner, a candidate keywords list may be generated in an iterative manner in which any identifiable parent of an interaction code description that has been appended to the candidate keywords list is also appended to the candidate keywords list. In some examples, only a subset of identifiable parents is included in the candidate keywords list. For example, for larger interaction corpuses (e.g., with five or more layers), one or more upper layers may be filtered from a candidate keywords list for an interaction code. As an example, the bottom five layers may be leveraged for a candidate keywords list. In smaller hierarchies (e.g., with less than five layers), none of the upper layers may be removed. In some examples, the number of layers may be based on a relevance threshold.

In this manner, an interaction code may be used to identify an initial node (e.g., on a first level) corresponding to an interaction code description of an interaction corpus. Based on the hierarchical structure of the interaction corpus, one level above the initial node, a parent node (e.g., on a second level) corresponding to another interaction code description may be identified. The parent node one level above the initial node may be a child node to another parent node (e.g., on a third level) corresponding to another interaction code description two levels above the initial node. In this manner, a nth level parent of an initial node may be identified, a corresponding interaction code description may be extracted, and the interaction code description may be appended to the candidate keywords for the interaction code.

In some embodiments, the term “modified candidate keywords list” refers to a data structure that describes a set of one or more words (e.g., word-level tokens, etc.) from the candidate keywords list. For example, a modified candidate keywords list may include an expanded candidate keyword list, a pruned keyword list, a sorted keywords list, a filtered keyword list, and/or the like.

A pruned keyword list, for example, may be generated by pruning a candidate keywords list using a domain-specific corpus. For example, a domain-specific term corpus may include a plurality of words associated with a domain-specific term corpus. Each stop word may reflect a term within a prediction domain that lacks a predictive relevance (e.g., common and unlikely to contain high importance in determining a semantic meaning of a corpus or text). A stop word, for example, may be identified based on an occurrence frequency of a term across a plurality of features and/or outputs for the prediction domain. In some examples, the pruned keyword list may be generated by identifying and removing one or more stop words from a candidate keywords list. In this manner, a domain-specific term corpus may be used to prune one or more tokens from a candidate keywords list, resulting in a first type of modified candidate keywords list (e.g., a pruned keyword list).

In some embodiments, one or more additional modified keyword lists may be generated from the candidate keywords list and/or pruned keywords list. For instance, a filtered keywords list may be generated by further filtering one or more tokens from the pruned keywords list. In some examples, the filtered keywords list may be filtered according to a metric. For example, an inverse document frequency (IDF) scoring mechanism may be applied to a keywords list (e.g., candidate, pruned, etc.) to generate a frequency score for each token within the keywords list. In some examples, the filtered keyword list may be generated by identifying and removing one or more tokens from a keywords list with a frequency score that exceeds a frequency threshold (e.g., 0.75). In this manner, an IDF scoring mechanism may be used to filter one or more tokens from a keywords list, resulting in a second type of modified candidate keywords list (e.g., a filtered keyword list).

In some embodiments, an expanded keywords list may be generated from one or more of the candidate keywords list, the pruned keywords list, and/or the filtered keywords list. The expanded keywords list may be generated based on one or more embedding similarities between one or more tokens of a keywords list. For example, a token-level candidate keyword embedding may be generated, using an embedding model, for each candidate token of a keyword list to covert each candidate token to an embedding space. The embedding model may include any type of embedding model, such as BioWord2Vec, a domain-specific machine learning embedding model, and/or the like. The plurality of token-level candidate keyword embeddings may be compared to a plurality of candidate expansion token embeddings within the embedding space to identify one or more expansion tokens for each of the token-level candidate keyword embeddings. In some examples, the one or more expansion tokens may include the N most similar tokens for each candidate token based on a cosine similarity between a respective token-level candidate keyword embedding and the plurality of candidate expansion token embeddings. For example, the one or more expansion tokens may include one or more tokens that satisfy an expansion similarity threshold and an expansion threshold. In addition, or alternatively, the one or more related tokens may include the N most similar tokens to an average embedding for the plurality of token-level candidate keyword embeddings.

In some embodiments, the expanded keywords list may be generated by adding the one or more expansion tokens for each candidate token of a keywords list to the keywords list. In addition, or alternatively, the expanded keywords list may be generated by adding the one or more expansion tokens for each candidate token of a subset of candidate tokens of the keywords list to the keywords list. The subset of candidate tokens, for example, may include one or more candidate tokens extracted from an interaction code description for an interaction code corresponding to the keywords list (e.g., not the related interaction code descriptions for the interaction code). In this manner, a subset of candidate tokens that most closely related to an interaction code may be expanded without introducing potential noise from related, contextual information, such as related interaction code descriptions for an interaction code.

In some embodiments, the term “domain-specific term corpus” refers to a collection of terms that are associated with a specific domain. In some examples, a domain-specific term corpus may include different sets of terms with semantic similarity or relevance to a particular prediction domain. For example, in a clinical context, a domain associated with a domain-specific term corpus may be a medical domain. In such a case, the domain-specific term corpus may include terms, such as “patient,” “doctor,” and/or other clinical terms that fail to add a predictive meaning for a portion of text.

In some embodiments, the term “interaction-specific keywords list” refers to a data structure that describes a set of one or more words (e.g., word-level tokens, etc.) that are relevant to an interaction code and an interaction data object. In some examples, an interaction-specific keywords list may be generated from a keywords list, such as one or more candidate keywords lists 308, modified candidate keywords lists, and/or the like, that are related to an interaction description for an interaction data object. For example, an interaction description may be compared with one or more keywords lists to extract one or more word-level tokens for a particular interaction data object. In some examples, the one or more keywords lists may be identified from a plurality of keywords lists respectively corresponding to a plurality of interaction codes. For instance, one or more interaction codes may be identified within the interaction data object and the one or more keywords lists may respectively correspond to the one or more interaction codes.

In some embodiments, each keyword token from the one or more keywords lists is compared with each description token of an interaction description to identify one or more token matches, such as exact matches, fuzzy matches, and/or the like. For example, one or more exact syntactic matches may be identified based on a character-level comparison between the plurality of keyword tokens and a plurality of description tokens. In addition, or alternatively, one or more fuzzy syntactic matches may be identified to allow for minor variations in the character-level text to allow for typographical and/or other errors within the interaction description.

In some embodiments, one or more keyword tokens from the one or more keywords lists may be selected for an interaction-specific keywords list based on one or more exact matches, one or more fuzzy matches, and/or one or more embedding similarity measures. For instance, a cross-token similarity score may be generated for each keyword token based on a comparison between a corresponding token-level candidate keyword embedding and a plurality of token-level interaction description embeddings respectively corresponding to a plurality of description tokens from the interaction description. Candidate tokens corresponding to cross-token similarity scores that satisfy a similarity threshold and a limit threshold may be included in the keywords list. In this manner, a plurality of keyword tokens of an interaction-specific keywords list may be tailored to an interaction data object based on a syntactic and semantic similarity between the keyword tokens and an interaction description.

In some embodiments, an interaction-specific keywords list may be surfaced to a user, via a user interface, to provide document insights for an interaction data object. For example, in a clinical context, an interaction-specific keywords list may be used by a clinical expert in review of a medical record (e.g., interaction description of a data object). In some examples, an interaction-specific keywords list may be used to perform one or more prediction-based actions. For example, a keywords list may be used to highlight terms, apply a color gradient to terms, and/or the like, that are identified based on the interaction-specific keywords list.

In some embodiments, the term “prediction-based action” refers to an action that may be initiated in response to one or more predictions of the present disclosure, such as the generation of an interaction-specific keywords list. A prediction-based action, for example, may be intelligently selected, using some of the techniques of the present disclosure, based on an interaction-specific keywords list. A prediction-based action may depend on the prediction domain. For example, in a clinical context, a prediction-based action may be the modification (e.g., highlighting, color changing, etc.) of one or more terms within a user interface reflective of an interaction description.

In some embodiments, the term “ordering scheme” refers to an ordering rule set for a keyword list. An ordering scheme, for example, may apply one or more logical conditions and/or predefined rules to a keyword list to rearrange an ordering of one or more keyword tokens therein. In one example, an ordering scheme may be based on an IDF score for each of the keyword tokens with respect to an interaction description. In another example, the ordering scheme may be based on one or more similarity scores between each of the keyword embeddings of the keyword tokens and the token-level interaction description embeddings of an interaction description. In some examples, an ordering scheme may be used in a prediction-based action. For example, in a case where a prediction-based action is to apply a color gradient to keywords of a keywords list, the color gradient may be applied based on the ordering scheme (e.g., the first 3 keyword tokens may correspond to a green color gradient, the next 3 keyword tokens may correspond to a yellow color gradient, etc.).

In some embodiments, the term “relevance threshold” refers to a data entity that describes a threshold criterion for inclusion in the candidate keywords list. The relevance threshold, for example, may include a static and/or dynamic value, range of values, percentage, real number, ratio, numeric, and/or the like. In some examples, the relevance threshold may be tailored to increase or decrease the number of related interaction code descriptions that satisfy the relevance threshold. In some examples, the relevance threshold may be used to determine a nth level parent of a hierarchy when appending related interaction code descriptions from an interaction corpus to an interaction code description for an interaction code. For example, a relevance threshold may be used to subset a candidate keywords list such that the candidate keywords list only includes interaction code descriptions from the first N (e.g., 5) levels of a hierarchy including the initial interaction code description. In another example, a relevance threshold may be used to subset a candidate keywords list such that the last N (e.g., 2) levels of a hierarchy are removed from the candidate keywords list. In some examples, a relevance threshold may be determined based on a number of interaction code descriptions or levels of a hierarchy that are appended to a candidate keywords list. For example, if the candidate keywords list includes over a certain amount of interaction code descriptions (e.g., more than 5 levels) then a relevance threshold may be used to subset a candidate keywords list such that the candidate keywords list only includes related interaction code descriptions from the first N (e.g., 5) levels of a hierarchy including the initial interaction code description. In another example, if the candidate keywords list includes a certain amount of interaction code descriptions within a range (e.g., between 2 and 5) then a relevance threshold may be used to subset a candidate keywords list such that the last N (e.g., 2) levels of a hierarchy are removed from the candidate keywords list. In another example, if the candidate keywords list includes less than a certain amount of interaction code descriptions (e.g., less than 2) then a relevance threshold may be set such that the candidate keywords list is not changed.

In some embodiments, the term “domain-specific machine learning embedding model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A domain-specific machine learning embedding model may include one or more machine learning models configured, trained (e.g., jointly, separately, etc.), and/or the like to encode textual data into one or more embeddings. A domain-specific machine learning embedding model may include one or more of any type of machine learning model including one or more supervised, unsupervised, semi-supervised, reinforcement learning models, and/or the like. In some examples, a domain-specific machine learning embedding model may include multiple models configured to perform one or more different stages of an embedding process.

In some embodiments, a domain-specific machine learning embedding model is trained using one or more supervised training techniques. In some examples, a domain-specific machine learning embedding model may be trained to factorize one or more inputs, such as one or more text strings, to generate an embedded vector. In some examples, a machine learning embedding model may be trained such that the model's latent space is representative of certain semantic domains/contexts, such as a clinical domain. For example, a domain-specific machine learning embedding model may be trained to generate embeddings representative of one or more learned (and/or prescribed, etc.) relationships between one or more tokens (e.g., terms, phrases, and/or sentences). By way of example, a domain-specific machine learning embedding model may represent a semantic meaning of a term and/or sentence differently in relation to other terms and/or sentences, and/or the like. The domain-specific machine learning embedding model may include any type of embedding model finetuned on information for a particular search domain. By way of example, a domain-specific machine learning embedding model may include one or more of BioWord2 Vec, SBER, ClinicalBERT, BERT, GloVe, Doc2Vec, InferSent, Universal Sentence Encoder, a custom-built embedding model, and/or the like.

In some embodiments, the term “token-level candidate keyword embedding” refers to a data entity that describes a representation of a token of a candidate keyword (e.g., candidate token) from a modified candidate keywords list. In some examples, a token-level candidate keyword embedding may be generated from a candidate token using a domain-specific machine learning embedding model. A token-level candidate keyword embedding, for example, may include a text embedding including a real-valued vector that encodes one or more attributes for a candidate token.

In some embodiments, the term “token-level interaction description embedding” refers to a data entity that describes a representation of a token of an interaction description (e.g., description token) from an interaction data object. In some examples, a token-level interaction description embedding may be generated from a description token using a domain-specific machine learning embedding model. A token-level interaction description embedding, for example, may include a text embedding including a real-valued vector that encodes one or more attributes for a description token.

In some embodiments, the term “candidate token” refers to a data entity that describes a set of one or more characters within a keywords list. For example, a candidate token may describe one or more characters, a single word, a set of words, and/or the like. In some examples, a variety of text tokenization methods, operations, functions, and/or techniques may be utilized to separate/identify terms within a candidate keywords list that may be identified as candidate tokens. In some examples, a candidate token may be used to generate an embedding. In some examples, a candidate token is a single word used as a basis for a word-level embedding.

In some embodiments, the term “cross-token similarity score” refers to a data entity that describes a similarity score between two embeddings of two respective tokens. For example, a cross-token similarity score may represent a similarity score between a token-level candidate keyword embedding and a token-level interaction description embedding. In another example, a cross-token similarity score may represent a similarity score between a token-level candidate keyword embedding and a candidate expansion token embedding. In some examples, a cross-token similarity score may describe a measure of deviation between embeddings. In some examples, a cross-token similarity score may be generated by a domain-specific machine learning embedding model. A cross-token similarity score, for example, may be a cosine similarity score or any other similarity score. In some examples, a cross-token similarity score may include a static and/or dynamic value, range of values, percentage, real number, ratio, numeric, and/or the like. By way of example, a cross-token similarity score may be 0.7, 0.9, 0.99, or any other value.

In some embodiments, the term “similarity threshold” refers to a data entity that describes a threshold criterion for a pair of embeddings. For example, a similarity threshold may be used as threshold criteria for a cross-token similarity score. In some examples, a similarity threshold may be used in combination with one or more expansion token similarity scores to identify one or more expansion tokens. In some examples, a similarity threshold may be used in generating a keywords list. The similarity threshold, for example, may include a static and/or dynamic value, range of values, percentage, real number, ratio, numeric, and/or the like. By way of example, a similarity threshold may be 0.7, 0.75, 0.9, or any other value. In some examples, the similarity threshold may be tailored to increase or decrease the number of data objects that satisfy the similarity threshold.

In some embodiments, the term “limit threshold” refers to a data entity that describes a threshold criterion for inclusion in an interaction-specific keywords list. The limit threshold, for example, may include a static and/or dynamic value, range of values, percentage, real number, ratio, numeric, and/or the like. By way of example, a limit threshold may be 1, 2, 5, or any other value. In some examples, the limit threshold may be tailored to increase or decrease the number of data objects that satisfy the limit threshold.

In some embodiments, the term “expansion token” refers to a data entity that describes a set of one or more characters. For example, an expansion token may describe a subset of a word, a single word, a set of words, and/or the like. In some examples, a variety of text tokenization methods, operations, functions, and/or techniques may be utilized to separate/identify terms to be expansion tokens. In some examples, an expansion token may be identified using a domain-specific machine learning embedding model. In some examples, an expansion token may be added to a modified candidate keywords list based on an expansion token similarity score, an expansion similarity threshold, and/or an expansion threshold. For example, plurality of candidate expansion tokens may each be associated with a candidate expansion token embedding that satisfies an expansion similarity threshold when compared with a token-level candidate keywords embedding. A select number of expansion tokens may then be identified from the plurality of candidate expansion tokens based on an expansion threshold (e.g., top 2, etc.).

In some embodiments, the term “expansion token similarity score” refers to a data entity that describes a similarity score between a token-level candidate keyword embedding and a candidate expansion token embedding. For example, an expansion token similarity score may describe a measure of deviation (e.g., a cosine similarity, etc.) between a token-level candidate keyword embedding and a candidate expansion token embedding. An expansion token similarity score may be generated by a domain-specific machine learning embedding model. An expansion token similarity score may be used in combination with an expansion similarity threshold and/or an expansion threshold to identify one or more expansion tokens to be added to a modified candidate keywords list.

In some embodiments, the term “candidate expansion token” refers to a data entity that describes a set of one or more characters that is a candidate for being an expansion token. In some examples, a candidate expansion token may be generated by a domain-specific machine learning embedding model. For example, a domain-specific machine learning embedding model. By way of example, each token-level candidate keyword embedding in a candidate keywords list may be used in combination with a domain-specific machine learning embedding model to identify one or more candidate expansion tokens. The one or more candidate expansion tokens may be compared to a token-level candidate keyword embedding in the candidate keywords list via an expansion token similarity score. If the candidate expansion token similarity score satisfies a similarity threshold, and the candidate expansion token satisfies an expansion threshold, the candidate expansion token may be selected as an expansion token and added to the modified candidate keywords list. In some examples, a token-level candidate keyword embedding from the candidate keywords list are only used to generate candidate expansion tokens if the token-level candidate keyword embedding is sourced from certain levels of an interaction corpus. For example, it may be desirable that only a token-level candidate keyword embedding sourced from the initial interaction code description matched from an interaction corpus be used to generate candidate expansion tokens. In some examples, an average embedding for a plurality token-level candidate keyword embeddings sourced from the initial interaction code description are used rather than considering each embedding individually. In such a case, the average embedding may be used in combination with the domain-specific machine learning embedding model in order to generate candidate expansion tokens.

In some embodiments, the term “expansion similarity threshold” refers to a data entity that describes a threshold criterion for a pair of embeddings. For example, an expansion similarity threshold may be used as threshold criteria for a cross-token similarity score. In some examples, an expansion similarity threshold may be used in combination with one or more expansion token similarity scores to identify one or more expansion tokens. In some examples, an expansion similarity threshold may be used in generating a keywords list. The expansion similarity threshold, for example, may include a static and/or dynamic value, range of values, percentage, real number, ratio, numeric, and/or the like. By way of example, an expansion similarity threshold may be 0.7, 0.75, 0.9, or any other value. In some examples, the expansion similarity threshold may be tailored to increase or decrease the number of data objects that satisfy the similarity threshold.

In some embodiments, the term “expansion threshold” refers to a data entity that describes a threshold criterion for inclusion in the modified candidate keywords list. The expansion threshold, for example, may include a static and/or dynamic value, range of values, percentage, real number, ratio, numeric, and/or the like. In some examples, the expansion threshold may be tailored to increase or decrease the number of data objects that satisfy the expansion threshold. An expansion threshold may be used in combination with an expansion token similarity score and/or an expansion similarity threshold to identify one or more expansion tokens for inclusion in a modified candidate keywords list.

In some embodiments, the term “fuzzy matching score” refers to a data entity that describes a score assigned to a fuzzy matching process. For example, a fuzzy matching may be based on a comparison between tokens where the tokens do not have to have an exact match but allow for some variation. The fuzzy match may allow identification of non-identical duplicates between data sets by specifying parameters to match on. For example, a fuzzy match may define parameters or algorithm to score how similar two tokens are. In some examples, a fuzzy matching score may be used to circumvent inaccuracies in interaction descriptions in cases where an interaction description goes through a process of optical character recognition, an interaction description contains typos, errors, and/or the like.

In some embodiments, the term “secondary keywords list” refers to a keywords list sourced from a secondary interaction corpus. For example, a secondary interaction corpus may be used to generate a secondary keywords list to expand and/or replace information provided by a keywords list. For example, one or more secondary candidate keyword tokens may be identified from a secondary interaction corpus. The one or more secondary candidate keywords tokens may be filtered, pruned, expanded, and/or the like in accordance with one or more embodiments described herein. In some examples, one or more secondary candidate keywords tokens may be selected for a secondary keywords list based on one or more exact matches, one or more fuzzy matches, and/or one or more embedding similarity measures in accordance with one or more embodiments described herein. In some examples, a cross-token similarity score may be generated for each secondary candidate keyword token based on a comparison between a corresponding secondary token-level candidate keyword embedding and a plurality of token-level interaction description embeddings respectively corresponding to a plurality of description tokens from the interaction description. Secondary candidate keyword tokens corresponding to cross-token similarity scores that satisfy a similarity threshold (e.g., 0.9) and/or a limit threshold may be included in the keywords list. Additionally, or alternatively, a cross-token similarity score may be generated for an average embedding for one or more secondary candidate keyword tokens.

### IV. OVERVIEW

Some embodiments of the present disclosure provide machine learning, computer processing, and data matching techniques that improve the efficiency, reliability, and latency of computer-based keyword identification. Traditional approaches for keyword identification leverage robust datasets and that require large computational resources at runtime. Such datasets may include keyword terms that are relevant to a search, but unrecognizable to a user or too specific to help navigate a user interface using the keyword terms. Such results accomplish one goal of interface navigation (e.g., finding relevant keywords) at the expense of usability and therefore may be evaluated as achieving high performing results without practically improving interface navigation for a user. Some techniques of the present disclosure address these technical challenges through a sequence of generative and matching processes in which keyword lists are curated and surfaced based on both (1) their relevance to a document and (2) the anticipated knowledge of a user within a search domain. In this regard, the keyword lists may be constrained to the anticipated knowledge of a user and may be predetermined, offline to improve the computational costs and retrieval speed of keywords. This, in turn, may allow for real-time interface navigation using keywords that are both interpretable and relevant to a document.

More particularly, some embodiments of the present disclosure provide complementary offline and online processes for generating and then surfacing keywords that are tailored to a particular search domain. The offline process may be continuously performed to dynamically update keyword lists for retrieval during an online retrieval process. In this manner, keywords may be generated and/or modified asynchronously with the retrieval of one or more of the keywords for a particular use case. In some examples, a plurality of keywords lists may be stored and organized within a datastore to support an efficiency retrieval and matching process. For example, the plurality of keywords lists may be stored in association with one or more defined codes associated with a search domain. In this way, during an online retrieval process, a targeted keywords list may be received from the datastore that corresponds to a code identified within a document associated with the retrieval task. The targeted keywords list may provide a constrained set of keywords that may be leveraged to perform various text matching techniques with respect to the document in order to surface relevant keywords based on the text of the document. Using the matching techniques of the present disclosure, a ranked set of keywords may be surfaced to a user and used to initiate a prediction-based action, such as highlighting keywords of the provided text for a user, navigating between sections of a user interface based on the keywords, and/or the like. In this way, and by splitting various operations between offline and online processes, some embodiments of the present disclosure enable practically relevant results while achieving efficient runtime processing to overcome various processing challenges unique to computers and, more specifically, techniques with respect to keyword identification and dynamic interface navigation.

In some embodiments, a keywords list is generated for any search domain by using a sequence of machine learning techniques to intelligently extract, refine, and then expand a list of interpretable terms from a corpus of domain knowledge for the search domain. For example, some embodiments of the present disclosure leverage interaction corpuses which may provide high quality, relevant, and expected keywords to a user. Generative techniques based on the interaction corpuses provide ideal sources for identifying keywords related to given codes within a search domain. In some embodiments, the techniques described herein may be applied to a secondary corpus to generate a secondary keywords list to further improve the quantity and quality of identified keywords. In some examples, a keywords list may be extracted from the interaction corpuses and/or secondary corpuses, tokenized, and then embedded using a domain-specific machine learning embedding model. The embedded keywords may be expanded upon using, for example, expansion tokens that are semantically similar to the extracted keywords while remaining interpretable to a user. By doing so, the generative techniques described herein may allow for the generation of keywords that are grounded by the domain knowledge of a user to ensure interpretability at runtime.

In some embodiments, one or more keywords are surfaced to a user, for a particular retrieval task, from a plurality of search domain specific keyword lists. By pre-filtering candidate keywords using the predetermined keyword lists described herein, relevant keywords may be intelligently surfaced at runtime using a sequence of matching techniques that assess a syntactic, fuzzy syntactic, and sematic similarity between each of the candidate keywords and a text description associated with the retrieval task. For example, matching keywords may be identified using a fuzzy matching operation, an embedding matching operation, and/or an exact matching operation between the pre-filtered candidate keywords and an interaction description. By doing so, keywords may be identified in an interaction description even in cases where the interaction description contains words that are syntactically different but semantically similar to the keywords or in cases where the interaction description contains syntactic errors.

Examples, of technologically advantageous embodiments of the present disclosure include: (i) generative techniques for generating keywords lists that are tailored to a search domain to improve interpretability, (ii) matching techniques for identifying relevant and interpretable keywords in real time, (iii) user interface navigation techniques to address small interface screens by leveraging tailored keywords to navigate within a large document, among others. Other technical improvement and advantages may be realized by one of ordinary skill in the art.

### V. EXAMPLE SYSTEM OPERATIONS

As indicated, various embodiments of the present disclosure make important technical contributions to computer efficiency and keyword identification technologies. In particular, systems and methods are disclosed herein that present generative and matching techniques for continuously and asynchronously generating keywords lists to facilitate real-time prediction-based actions and improve the predictive accuracy of keyword identification techniques in complex search domains. Unlike traditional keyword identification techniques, the techniques of the present disclosure leverage asynchronous offline and online processes, generative, machine learning, and matching techniques, to identify keywords, which may improve computational efficiency and user experience in search domains.

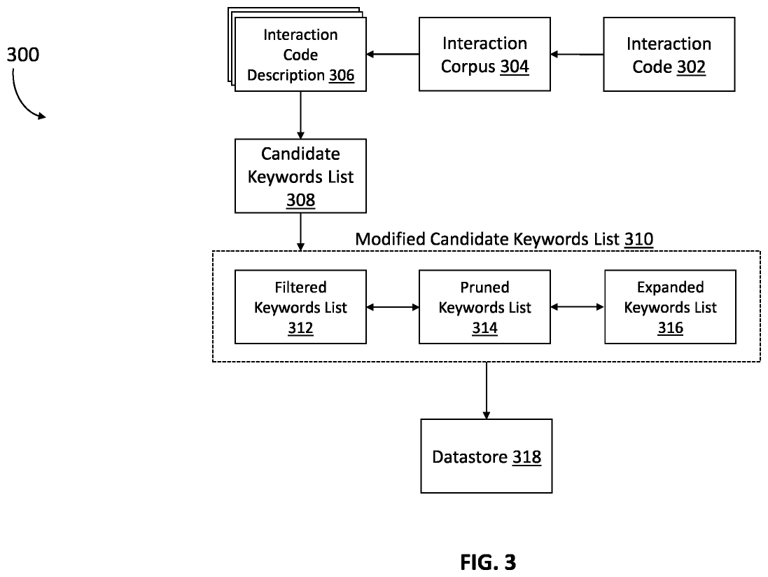

FIG. 3 is a dataflow diagram 300 showing example data structures and modules for generating a comprehensive search keyword list in accordance with some embodiments discussed herein. The dataflow diagram 300 depicts generative techniques in which modified candidate keywords lists 310 are generated to populate a datastore 318 for each of a plurality of interaction codes 302 associated with a particular search domain. For instance, using some of the techniques of the present disclosure, a datastore 318 may be populated to facilitate a search and retrieval process that is tailored to a particular search domain. To do so, the modified candidate keywords lists 310 may be iteratively generated from interaction code descriptions 306 of an interaction corpus 304 for a search domain to surface relevant keywords that are both related to interaction codes 302 and recognizable to users within the domain.

In some embodiments, an interaction code 302 is identified from an interaction corpus 304. In some examples, the interaction code 302 may be one of a plurality of interaction codes defined by the interaction corpus 304 for a prediction domain. By way of example, a modified candidate keywords list 310 may be generated, using some of the techniques described herein, for each of a plurality of interaction codes defined by the interaction corpus 304. In addition, or alternatively, the interaction code 302 may be identified from a subset of the plurality interaction codes. For instance, a modified candidate keywords list 310 may be generated, using some of the techniques described herein, for each of a selected subset of the plurality of interaction codes defined by the interaction corpus 304. By way of the example, the selected subset of the plurality of interaction codes may be based on usage frequency across a plurality of historical interaction data object, and/or the like.

In some embodiments, an interaction code 302 is a data entity that describes a predictive classification for a prediction domain. An interaction code 302 may include a predefined alpha-numeric identifier that identifies one or more observed characteristics within a prediction domain. In some examples, an interaction code 302 may correspond to an event and/or procedure for an entity within the prediction domain. By way of example, and continuing with the clinical prediction domain, the event may include a diagnosis for a disease corresponding to the interaction code 302. In another example, the event may include a procedure corresponding to treating a disease. For instance, an interaction code 302 may include one or more codes such as ICD-10-CM codes, Current Procedural Terminology (CPT) codes, Healthcare Common Procedure Codding System (HCPCS) codes, and/or the like.

In some embodiments, the interaction corpus 304 comprises a hierarchical node structure and the initial subset of the plurality of token-level candidate keyword embeddings correspond to a subset of the plurality of candidate tokens of the modified candidate keywords list 310 that are associated with an initial layer of the hierarchical node structure.

In some embodiments, an interaction corpus 304 is a collection or repository of information relevant to one or more interaction codes 302. For example, an interaction corpus 304 may be or include a metathesaurus, semantic network, lexicon, and/or the like. In some examples, an interaction corpus 304 includes a plurality of interaction codes 302, interaction code descriptions 306, and/or other contextual supplementary information that may be related to an interaction code 302. In some examples, an interaction corpus 304 may be leveraged to generate one or more keywords for an interaction code 302.

For example, in a clinical context, an interaction corpus 304 may include a plurality of textual descriptions associated with medical codes (e.g., billable diagnosis and/or procedural codes, etc.) of a medical record (e.g., interaction data object). By way of example, the interaction corpus 304 may include the UMLS database, an E&M checklist, and/or any other source of text to describe a medical code.

In some embodiments, an interaction corpus 304 defines a set of relationships between a plurality of interaction codes 302 and/or interaction code descriptions 306. For example, an interaction corpus 304 may define a mapping between an interaction code 302 and an interaction code description 306. For instance, the interaction corpus 304 may include a one-to-one mapping, one-to-many mapping, many-to-many mapping, and/or the like, between an interaction code 302 and an interaction code description 306.

In some embodiments, an interaction corpus 304 may define a hierarchical, graph-based, and/or other complex set of relationships between one or more interaction codes 302. For example, an interaction corpus 304 may contain a hierarchical structure that defines root nodes, leaf nodes, and dependency relationships between a plurality of parent-child nodes. For instance, an interaction corpus 304 may define a plurality of nodes corresponding to a plurality of interaction code descriptions 306 where each node may have a parent node and/or a child node and each node may be a parent node or child node with respect to another node. In some examples, each child and parent node may correspond to different levels of the hierarchical structure.

In some embodiments, an interaction corpus 304 may have properties that correspond to using various n-gram tokenization methods. In some examples, an interaction corpus 304 may not include well-defined documentation requirements such that the interaction corpus 304 contains low quality or unreliably structured interaction code descriptions 306. In such a case, unigrams may be used during tokenization operations applied to one or more interaction code descriptions 306. In some examples, an interaction corpus 304 may include well-defined documentation requirements such that the interaction corpus 304 contains high quality or reliably structured interaction code descriptions 306. In such a case, it may be preferred that greater n-gram (e.g., bigrams) are used during tokenization operations applied to the interaction code descriptions 306.

In some embodiments, an interaction code description 306 is semantic content such as a structured and/or natural language sequence of text that describes a meaning, purpose, and/or context of an interaction code 302. An interaction code description 306, for example, may include structured and/or natural language text corresponding to an interaction code 302. The structured and/or natural language text may include a manual, automated, and/or semi-automated text annotation provided for an interaction code 302. For example, an interaction code description 306 may include one or more segments of text from one or more interaction corpuses, dictionaries, and/or the like that define one or more of a plurality of interaction codes 302. In this manner, an interaction code description 306 may be used to identify contextual information, such as medically relevant information in a clinical context, relating to an event recorded by an interaction code 302 within an interaction data object.

By way of example, in a clinical prediction domain, an interaction code description 306 may include clinically relevant information corresponding to an interaction code 302. For instance, an interaction code description 306 may be a standardized and/or non-standardized description associated with a particular medical code, such as anICD-10 code, CPT code, and/or the like, that describes relevant clinical information, such as the name, uses, symptoms, history, methods, abnormal findings, and/or the like, of a corresponding diagnosis, procedure, and/or the like. In such a case, the interaction code description 306 may be accessed from an interaction corpus 304, such as the Unified Medical Language System (UMLS) database, an Extended Evaluation and Management (E&M) checklist, and/or the like.

In some embodiments, a candidate keywords list 308 is a data structure that describes a set of one or more words (e.g., word-level tokens, etc.) that are relevant to an interaction code 302. For example, a keyword list may be generated for a prediction domain based on a plurality of candidate keyword lists respectively generated for each of a plurality of interaction codes 302 defined for the prediction domain. In some examples, each of the one or more terms of a candidate keywords list 308 may be a candidate for inclusion in a keywords list for a particular interaction code 302. For example, a candidate keywords list 308 may include a superset of tokens from which a subset of keywords may be selected. In some examples, a candidate keywords list 308 may be modified, expanded, pruned, and/or generally manipulated. In some examples, the one or more terms of a candidate keywords list 308 may be a token or associated with a token.

In some embodiments, a candidate keywords list 308 is generated from one or more interaction code descriptions 306 of an interaction corpus 304 and/or secondary interaction corpus. For example, a candidate keywords list 308 may include an interaction code description 306 identified by matching an interaction code 302 of an interaction data object to an interaction code description 306 of an interaction corpus 304. In some examples, the candidate keywords list 308 may include the interaction code description 306 for the interaction code 302 and/or one or more related interaction code descriptions from the interaction corpus 304. For instance, the interaction code description 306 may include an initial candidate keywords list 308 and one or more related interaction code descriptions may be iteratively identified and appended to the initial candidate keywords list 308 to generate a candidate keywords list 308.

For example, in the event that an interaction corpus 304 defines a hierarchical structure, a candidate keywords list 308 may include one or more related interaction code descriptions for one or more parent and/or child nodes to an interaction code 302. For instance, the one or more related interaction codes may correspond to one or more parent nodes to a particular interaction code 302. As an example, a candidate keywords list 308 may include an interaction code description 306 as well as its nth level parents. In this manner, a candidate keywords list 308 may be generated in an iterative manner in which any identifiable parent of an interaction code description 306 that has been appended to the candidate keywords list 308 is also appended to the candidate keywords list 308. In some examples, only a subset of identifiable parents is included in the candidate keywords list 308. For example, for larger interaction corpuses (e.g., with five or more layers), one or more upper layers may be filtered from a candidate keywords list 308 for an interaction code 302. As an example, the bottom five layers may be leveraged for a candidate keywords list 308. In smaller hierarchies (e.g., with less than five layers), none of the upper layers may be removed. In some examples, the number of layers may be based on a relevance threshold.

In this manner, an interaction code 302 may be used to identify an initial node (e.g., on a first level) corresponding to an interaction code description 306 of an interaction corpus 304. Based on the hierarchical structure of the interaction corpus 304, one level above the initial node, a parent node (e.g., on a second level) corresponding to another interaction code description 306 may be identified. The parent node one level above the initial node may be a child node to another parent node (e.g., on a third level) corresponding to another interaction code description 306 two levels above the initial node. In this manner, a nth level parent of an initial node may be identified, a corresponding interaction code description 306 may be extracted, and the interaction code description 306 may be appended to the candidate keywords for the interaction code 302.

In some embodiments, the interaction corpus 304 comprises a hierarchical node structure and generating the candidate keywords list 308 includes identifying an initial interaction code description 306 for the interaction code 302 from an initial node within the interaction corpus 304 that corresponds to the interaction code 302. In some examples, a plurality of subsequent hierarchical code descriptions is identified for a plurality of subsequent interaction codes that respectively correspond to a plurality of subsequent nodes within the interaction corpus 304. In some examples, the initial interaction code description 306 within the plurality of subsequent hierarchical code descriptions is appended to the candidate keywords list 308.

In some embodiments, each of the plurality of subsequent nodes is a parent node of the initial node within the hierarchical node structure.

In some embodiments, the plurality of subsequent nodes includes a subset of a plurality of parent nodes of the initial node and the subset of parent nodes is based on a relevance threshold.

In some embodiments, a relevance threshold is a data entity that describes a threshold criterion for inclusion in the candidate keywords list 308. The relevance threshold, for example, may include a static and/or dynamic value, range of values, percentage, real number, ratio, numeric, and/or the like. In some examples, the relevance threshold may be tailored to increase or decrease the number of related interaction code descriptions that satisfy the relevance threshold. In some examples, the relevance threshold may be used to determine a nth level parent of a hierarchy when appending related interaction code descriptions from an interaction corpus 304 to an interaction code description 306 for an interaction code 302. For example, a relevance threshold may be used to subset a candidate keywords list 308 such that the candidate keywords list 308 only includes interaction code descriptions from the first N (e.g., 5) levels of a hierarchy including the initial interaction code description 306. In another example, a relevance threshold may be used to subset a candidate keywords list 308 such that the last N (e.g., 2) levels of a hierarchy are removed from the candidate keywords list 308. In some examples, a relevance threshold may be determined based on a number of interaction code descriptions or levels of a hierarchy that are appended to a candidate keywords list 308. For example, if the candidate keywords list 308 includes over a certain amount of interaction code descriptions (e.g., more than 5 levels) then a relevance threshold may be used to subset a candidate keywords list 308 such that the candidate keywords list 308 only includes related interaction code descriptions from the first N (e.g., 5) levels of a hierarchy including the initial interaction code description 306. In another example, if the candidate keywords list 308 includes a certain amount of interaction code descriptions 306 within a range (e.g., between 2 and 5) then a relevance threshold may be used to subset a candidate keywords list 308 such that the last N (e.g., 2) levels of a hierarchy are removed from the candidate keywords list 308. In another example, if the candidate keywords list 308 includes less than a certain amount of interaction code descriptions (e.g., less than 2) then a relevance threshold may be set such that the candidate keywords list 308 is not changed.

In some embodiments, a modified candidate keywords list 310 is generated from a candidate keywords list 308. For example, a candidate keywords list 308 may be modified by one or more operations (e.g., filtering, pruning, expanding, etc.) to generate a modified candidate keywords list 310.

In some embodiments, a modified candidate keywords list 310 is a data structure that describes a set of one or more words (e.g., word-level tokens, etc.) from the candidate keywords list 308. For example, a modified candidate keywords list 310 may include an expanded keywords list 316, a pruned keywords list 314, a sorted keywords list, a filtered keywords list 312, and/or the like.

In some embodiments, a pruned keywords list 314 may be generated by pruning a candidate keywords list 308 using a domain-specific corpus. For example, a domain-specific term corpus may include a plurality of stop words associated with a domain-specific term corpus. Each stop word may reflect a term within a prediction domain that lacks a predictive relevance (e.g., common and unlikely to contain high importance in determining a semantic meaning of a corpus or text). A stop word, for example, may be identified based on an occurrence frequency of a term across a plurality of features and/or outputs for the prediction domain. In some examples, the pruned keyword list may be generated by identifying and removing one or more stop words from a candidate keywords list 308. In this manner, a domain-specific term corpus may be used to prune one or more tokens from a candidate keywords list 308, resulting in a first type of modified candidate keywords list 310 (e.g., a pruned keyword list).

In some embodiments, one or more additional modified keyword lists may be generated from the candidate keywords list 308 and/or pruned keywords list 314. For instance, a filtered keywords list 312 may be generated by further filtering one or more tokens from the pruned keywords list 314. In some examples, the filtered keywords list 312 may be filtered according to a metric. For example, an inverse document frequency (IDF) scoring mechanism may be applied to a keywords list (e.g., candidate, pruned, etc.) to generate a frequency score for each token within the keywords list. In some examples, the filtered keyword list may be generated by identifying and removing one or more tokens from a keywords list with a frequency score that exceeds a frequency threshold (e.g., 0.75). In this manner, an IDF scoring mechanism may be used to filter one or more tokens from a keywords list, resulting in a second type of modified candidate keywords list 310 (e.g., a filtered keyword list).

In some embodiments, an expanded keywords list 316 may be generated from one or more of the candidate keywords list 308, the pruned keywords list 314, and/or the filtered keywords list 312. The expanded keywords list 316 may be generated based on one or more embedding similarities between one or more tokens of a keywords list. For example, a token-level candidate keyword embedding may be generated, using an embedding model, for each candidate token of a keyword list to covert each candidate token to an embedding space. The embedding model may include any type of embedding model, such as BioWord2Vec, a domain-specific machine learning embedding model, and/or the like. The plurality of token-level candidate keyword embeddings may be compared to a plurality of candidate expansion token embeddings within the embedding space to identify one or more expansion tokens for each of the token-level candidate keyword embeddings. In some examples, the one or more expansion tokens may include the N most similar tokens for each candidate token based on a cosine similarity between a respective token-level candidate keyword embedding and the plurality of candidate expansion token embeddings. For example, the one or more expansion tokens may include one or more tokens that satisfy an expansion similarity threshold and an expansion threshold. In addition, or alternatively, the one or more related tokens may include the N most similar tokens to an average embedding for the plurality of token-level candidate keyword embeddings.

In some embodiments, the expanded keywords list 316 may be generated by adding the one or more expansion tokens for each candidate token of a keywords list to the keywords list. In addition, or alternatively, the expanded keywords list 316 may be generated by adding the one or more expansion tokens for each candidate token of a subset of candidate tokens of the keywords list to the keywords list. The subset of candidate tokens, for example, may include one or more candidate tokens extracted from an interaction code description 306 for an interaction code 302 corresponding to the keywords list (e.g., not the related interaction code descriptions for the interaction code). In this manner, a subset of candidate tokens that most closely related to an interaction code 302 may be expanded without introducing potential noise from related, contextual information, such as related interaction code descriptions for an interaction code 302.

In some embodiments, a domain-specific term corpus is a collection of terms that are associated with a specific domain. In some examples, a domain-specific term corpus may include different sets of terms with semantic similarity or relevance to a particular prediction domain. For example, in a clinical context, a domain associated with a domain-specific term corpus may be a medical domain. In such a case, the domain-specific term corpus may include terms, such as “patient,” “doctor,” and/or other clinical terms that fail to add a predictive meaning for a portion of text.

In some embodiments, the modified candidate keywords list 310 is expanded by identifying one or more expansion tokens for the modified candidate keywords list 310 using the domain-specific machine learning embedding model. For example, the one or more expansion tokens may be identified based on a plurality of expansion token similarity scores between an initial subset of the plurality of token-level candidate keyword embeddings and a plurality of candidate expansion token embeddings corresponding to a plurality of candidate expansion tokens, a similarity threshold, and an expansion threshold. In some examples, the one or more identified expansion tokens may be appended to the modified candidate keywords list 310.

In some embodiments, a domain-specific machine learning embedding model is a data entity that describes parameters, hyper-parameters, and/or defined operations of a rules-based and/or machine learning model (e.g., model including at least one of one or more rule-based layers, one or more layers that depend on trained parameters, coefficients, and/or the like). A domain-specific machine learning embedding model may include one or more machine learning models configured, trained (e.g., jointly, separately, etc.), and/or the like to encode textual data into one or more embeddings. A domain-specific machine learning embedding model may include one or more of any type of machine learning model including one or more supervised, unsupervised, semi-supervised, reinforcement learning models, and/or the like. In some examples, a domain-specific machine learning embedding model may include multiple models configured to perform one or more different stages of an embedding process.

In some embodiments, a domain-specific machine learning embedding model is trained using one or more supervised training techniques. In some examples, a domain-specific machine learning embedding model may be trained to factorize one or more inputs, such as one or more text strings, to generate an embedded vector. In some examples, a machine learning embedding model may be trained such that the model's latent space is representative of certain semantic domains/contexts, such as a clinical domain. For example, a domain-specific machine learning embedding model may be trained to generate embeddings representative of one or more learned (and/or prescribed, etc.) relationships between one or more tokens (e.g., terms, phrases, and/or sentences). By way of example, a domain-specific machine learning embedding model may represent a semantic meaning of a term and/or sentence differently in relation to other terms and/or sentences, and/or the like. The domain-specific machine learning embedding model may include any type of embedding model finetuned on information for a particular search domain. By way of example, a domain-specific machine learning embedding model may include one or more of BioWord2 Vec, SBER, ClinicalBERT, BERT, GloVe, Doc2Vec, InferSent, Universal Sentence Encoder, a custom-built embedding model, and/or the like.

In some embodiments, an expansion token is a data entity that describes a set of one or more characters. For example, an expansion token may describe a subset of a word, a single word, a set of words, and/or the like. In some examples, a variety of text tokenization methods, operations, functions, and/or techniques may be utilized to separate/identify terms to be expansion tokens. In some examples, an expansion token may be identified using a domain-specific machine learning embedding model. In some examples, an expansion token may be added to a modified candidate keywords list 310 based on an expansion token similarity score, an expansion similarity threshold, and/or an expansion threshold. For example, plurality of candidate expansion tokens may each be associated with a candidate expansion token embedding that satisfies an expansion similarity threshold when compared with a token-level candidate keywords embedding. A select number of expansion tokens may then be identified from the plurality of candidate expansion tokens based on an expansion threshold (e.g., top 2, etc.).

In some embodiments, an expansion token similarity score is a data entity that describes a similarity score between a token-level candidate keyword embedding and a candidate expansion token embedding. For example, an expansion token similarity score may describe a measure of deviation (e.g., a cosine similarity, etc.) between a token-level candidate keyword embedding and a candidate expansion token embedding. An expansion token similarity score may be generated by a domain-specific machine learning embedding model. An expansion token similarity score may be used in combination with an expansion similarity threshold and/or an expansion threshold to identify one or more expansion tokens to be added to a modified candidate keywords list 310.

In some embodiments, a token-level candidate keyword embedding is a data entity that describes a representation of a token of a candidate keyword (e.g., candidate token) from a modified candidate keywords list 310. In some examples, a token-level candidate keyword embedding may be generated from a candidate token using a domain-specific machine learning embedding model. A token-level candidate keyword embedding, for example, may include a text embedding including a real-valued vector that encodes one or more attributes for a candidate token.

In some embodiments, a candidate expansion token is a data entity that describes a set of one or more characters that is a candidate for being an expansion token. In some examples, a candidate expansion token may be generated by a domain-specific machine learning embedding model. For example, a domain-specific machine learning embedding model. By way of example, each token-level candidate keyword embedding in a candidate keywords list 308 may be used in combination with a domain-specific machine learning embedding model to identify one or more candidate expansion tokens. The one or more candidate expansion tokens may be compared to a token-level candidate keyword embedding in the candidate keywords list 308 via an expansion token similarity score. If the candidate expansion token similarity score satisfies a similarity threshold, and the candidate expansion token satisfies an expansion threshold, the candidate expansion token may be selected as an expansion token and added to the modified candidate keywords list 310. In some examples, a token-level candidate keyword embedding from the candidate keywords list 308 are only used to generate candidate expansion tokens if the token-level candidate keyword embedding is sourced from certain levels of an interaction corpus 304. For example, it may be desirable that only a token-level candidate keyword embedding sourced from the initial interaction code description 306 matched from an interaction corpus 304 be used to generate candidate expansion tokens. In some examples, an average embedding for a plurality token-level candidate keyword embeddings sourced from the initial interaction code description 306 are used rather than considering each embedding individually. In such a case, the average embedding may be used in combination with the domain-specific machine learning embedding model in order to generate candidate expansion tokens.

In some embodiments, an expansion similarity threshold is a data entity that describes a threshold criterion for a pair of embeddings. For example, an expansion similarity threshold may be used as threshold criteria for a cross-token similarity score. In some examples, an expansion similarity threshold may be used in combination with one or more expansion token similarity scores to identify one or more expansion tokens. In some examples, an expansion similarity threshold may be used in generating a keywords list. The expansion similarity threshold, for example, may include a static and/or dynamic value, range of values, percentage, real number, ratio, numeric, and/or the like. By way of example, an expansion similarity threshold may be 0.7, 0.75, 0.9, or any other value. In some examples, the expansion similarity threshold may be tailored to increase or decrease the number of data objects that satisfy the similarity threshold.

In some embodiments, an expansion threshold is a data entity that describes a threshold criterion for inclusion in the modified candidate keywords list 310. The expansion threshold, for example, may include a static and/or dynamic value, range of values, percentage, real number, ratio, numeric, and/or the like. In some examples, the expansion threshold may be tailored to increase or decrease the number of data objects that satisfy the expansion threshold. An expansion threshold may be used in combination with an expansion token similarity score and/or an expansion similarity threshold to identify one or more expansion tokens for inclusion in a modified candidate keywords list 310.

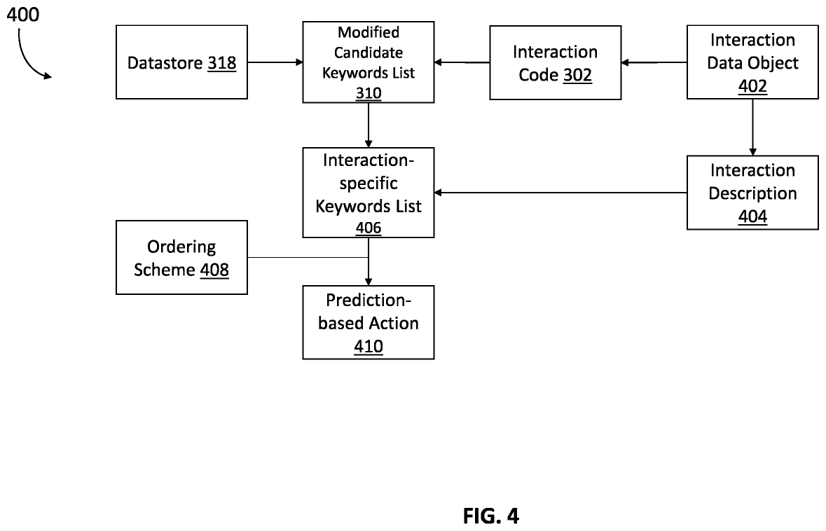

In some embodiments, a modified candidate keywords list 310 is stored for later use. For example, the modified candidate keywords list 310 may be stored in datastore 318. The modified candidate keywords list 310 may then be retrieved from datastore 318 for use in another process. For example, the modified candidate keywords list 310 may be retrieved from datastore 318 for use in generating an interaction-specific keywords list as will now further be described with reference to FIG. 4.

FIG. 4 is a dataflow diagram 400 showing example data structures for initiating a prediction-based action in accordance with some embodiments discussed herein. The dataflow diagram 400 depicts a prediction process for generating an interaction-specific keywords list 406 from a modified candidate keywords list 310 and an interaction description 404 of an interaction data object 402 and initiating a prediction-based action 410 based thereon.

In some embodiments, an interaction code 302 is identified based on an interaction data object 402. For example, the interaction code 302 may be identified from an interaction description of the interaction data object 402.

In some embodiments, an interaction data object 402 is a data entity that describes a recorded interaction. An interaction data object 402 may include one or more interaction codes 302 that describe one or more characteristics of the recorded interaction. Additionally, or alternatively, an interaction data object 402 may include contextual data associated with the one or more interaction codes 302. For example, an interaction data object 402 may include an interaction description 404 corresponding to the recorded interaction.

An interaction data object 402 may be associated with a different type of interaction based on a prediction domain. As one example, for a clinical domain, an interaction data object 402 may describe a medical record for a medical visit, medical claim, and/or the like.

In some embodiments, an interaction description 404 is semantic content that describes a meaning, purpose, and/or context of an interaction. An interaction description 404, for example, may include structured and/or natural language text included within and/or associated with an interaction data object 402 that describes an interaction. The interaction description 404, for example, may include one or more interaction codes 302, one or more contextual characteristics associated with the one or more interaction codes 302 and/or an interaction, and/or the like.

As an example, in a clinical prediction domain, an interaction description 404 may include clinically relevant information associated with a clinical visit. For instance, an interaction description 404 may be a standardized and/or non-standardized description associated with a particular clinical visit, a procedure performed during the clinical visit, diagnosis provided during the clinical visit, and/or the like. In some examples, an interaction description 404 may be a description associated with a medical claim and may be recorded by one or more healthcare professionals.

In some embodiments, an interaction description 404 may be tokenized. For example, an interaction description 404 may include, be made of, be used to identify, and/or the like, one or more description tokens.

In some embodiments, a description token is a data entity that describes a set of one or more characters within an interaction description 404. For example, a description token may describe one or more characters, a single word, a set of words, and/or the like. In some examples, a variety of text tokenization methods, operations, functions, and/or techniques may be utilized to separate/identify terms within an interaction description 404 that may be identified as description tokens. In some examples, a description token may be used to generate an embedding. By way of example, a description token may include a word-level token used to generate word-level embeddings of an interaction description 404.

In some embodiments, an interaction-specific keywords list 406 is generated based on a comparison between the modified candidate keywords list 310 and an interaction description 404 of the interaction data object 402.

In some embodiments, an interaction-specific keywords list 406 is a data structure that describes a set of one or more words (e.g., word-level tokens, etc.) that are relevant to an interaction code 302 and an interaction data object 402. In some examples, an interaction-specific keywords list 406 may be generated from a keywords list, such as one or more candidate keywords lists, modified candidate keywords lists 310, and/or the like, that are related to an interaction description 404 for an interaction data object 402. For example, an interaction description 404 may be compared with one or more keywords lists to extract one or more word-level tokens for a particular interaction data object 402. In some examples, the one or more keywords lists may be identified from a plurality of keywords lists respectively corresponding to a plurality of interaction codes 302. For instance, one or more interaction codes 302 may be identified within the interaction data object 402 and the one or more keywords lists may respectively correspond to the one or more interaction codes 302.

In some embodiments, each keyword token from the one or more keywords lists is compared with each description token of an interaction description 404 to identify one or more token matches, such as exact matches, fuzzy matches, and/or the like. For example, one or more exact syntactic matches may be identified based on a character-level comparison between the plurality of keyword tokens and a plurality of description tokens. In addition, or alternatively, one or more fuzzy syntactic matches may be identified to allow for minor variations in the character-level text to allow for typographical and/or other errors within the interaction description 404.

In some embodiments, one or more keyword tokens from the one or more keywords lists may be selected for an interaction-specific keywords list 406 based on one or more exact matches, one or more fuzzy matches, and/or one or more embedding similarity measures. For instance, a cross-token similarity score may be generated for each keyword token based on a comparison between a corresponding token-level candidate keyword embedding and a plurality of token-level interaction description embeddings respectively corresponding to a plurality of description tokens from the interaction description 404. Candidate tokens corresponding to cross-token similarity scores that satisfy a similarity threshold, and a limit threshold may be included in the keywords list. In this manner, a plurality of keyword tokens of an interaction-specific keywords list 406 may be tailored to an interaction data object 402 based on a syntactic and semantic similarity between the keyword tokens and an interaction description 404.

In some embodiments, generating the interaction-specific keywords list 406 includes generating a plurality of token-level candidate keyword embeddings for a plurality of candidate tokens of the modified candidate keywords list 310 using a domain-specific machine learning embedding model. In some embodiments, generating the interaction-specific keywords list 406 further includes generating a plurality of token-level interaction description embeddings for a plurality of description tokens of the interaction description 404 using the domain-specific machine learning embedding model, and generating the interaction-specific keywords list 406 by selecting one or more candidate tokens from the plurality of candidate tokens based on a plurality of cross-token similarity scores between the plurality of token-level candidate keyword embeddings and the plurality of token-level interaction description embeddings.

In some embodiments, a candidate token is a data entity that describes a set of one or more characters within a keywords list. For example, a candidate token may describe one or more characters, a single word, a set of words, and/or the like. In some examples, a variety of text tokenization methods, operations, functions, and/or techniques may be utilized to separate/identify terms within a candidate keywords list that may be identified as candidate tokens. In some examples, a candidate token may be used to generate an embedding. In some examples, a candidate token is a single word used as a basis for a word-level embedding.

In some embodiments, a token-level interaction description embedding is a data entity that describes a representation of a token of an interaction description 404 (e.g., description token) from an interaction data object 402. In some examples, a token-level interaction description embedding may be generated from a description token using a domain-specific machine learning embedding model. A token-level interaction description embedding, for example, may include a text embedding including a real-valued vector that encodes one or more attributes for a description token.

In some embodiments, a cross-token similarity score is a data entity that describes a similarity score between two embeddings of two respective tokens. For example, a cross-token similarity score may represent a similarity score between a token-level candidate keyword embedding and a token-level interaction description embedding. In another example, a cross-token similarity score may represent a similarity score between a token-level candidate keyword embedding and a candidate expansion token embedding. In some examples, a cross-token similarity score may describe a measure of deviation between embeddings. In some examples, a cross-token similarity score may be generated by a domain-specific machine learning embedding model. A cross-token similarity score, for example, may be a cosine similarity score or any other similarity score. In some examples, a cross-token similarity score may include a static and/or dynamic value, range of values, percentage, real number, ratio, numeric, and/or the like. By way of example, a cross-token similarity score may be 0.7, 0.9, 0.99, or any other value.

In some embodiments, a cross-token similarity score of the plurality of cross-token similarity scores comprises a fuzzy matching score.

In some embodiments, a fuzzy matching score is a data entity that describes a score assigned to a fuzzy matching process. For example, a fuzzy matching may be based on a comparison between tokens where the tokens do not have to have an exact match but allow for some variation. The fuzzy match may allow identification of non-identical duplicates between data sets by specifying parameters to match on. For example, a fuzzy match may define parameters or algorithm to score how similar two tokens are. In some examples, a fuzzy matching score may be used to circumvent inaccuracies in interaction descriptions in cases where an interaction description 404 goes through a process of optical character recognition, an interaction description 404 contains typos, errors, and/or the like.

In some embodiments, the one or more candidate tokens are based on a comparison between the plurality of cross-token similarity scores, a similarity threshold, and a limit threshold.

In some embodiments, a similarity threshold is a data entity that describes a threshold criterion for a pair of embeddings. For example, a similarity threshold may be used as threshold criteria for a cross-token similarity score. In some examples, a similarity threshold may be used in combination with one or more expansion token similarity scores to identify one or more expansion tokens. In some examples, a similarity threshold may be used in generating a keywords list. The similarity threshold, for example, may include a static and/or dynamic value, range of values, percentage, real number, ratio, numeric, and/or the like. By way of example, a similarity threshold may be 0.7, 0.75, 0.9, or any other value. In some examples, the similarity threshold may be tailored to increase or decrease the number of data objects that satisfy the similarity threshold.

In some embodiments a limit threshold is a data entity that describes a threshold criterion for inclusion in an interaction-specific keywords list 406. The limit threshold, for example, may include a static and/or dynamic value, range of values, percentage, real number, ratio, numeric, and/or the like. By way of example, a limit threshold may be 1, 2, 5, or any other value. In some examples, the limit threshold may be tailored to increase or decrease the number of data objects that satisfy the limit threshold.

In some embodiments, the performance of a prediction-based action 410 is initiated based on the interaction-specific keywords list 406.

In some embodiments, a prediction-based action 410 is an action that may be initiated in response to one or more predictions of the present disclosure, such as the generation of an interaction-specific keywords list 406. A prediction-based action 410, for example, may be intelligently selected, using some of the techniques of the present disclosure, based on an interaction-specific keywords list 406. A prediction-based action 410 may depend on the prediction domain. For example, in a clinical context, a prediction-based action 410 may be the modification (e.g., highlighting, color changing, etc.) of one or more terms within a user interface reflective of an interaction description 404.

In some embodiments, the prediction-based action 410 includes one or more of highlighting terms in the interaction description 404 based on the interaction-specific keywords list 406 or applying a color gradient to terms in the interaction description 404 based on the interaction-specific keywords list 406 and an ordering scheme 408.

In some embodiments, the ordering scheme 408 is an ordering rule set for a keyword list. The ordering scheme 408, for example, may apply one or more logical conditions and/or predefined rules to a keyword list to rearrange an ordering of one or more keyword tokens therein. In one example, an ordering scheme 408 may be based on an IDF score for each of the keyword tokens with respect to an interaction description 404. In another example, the ordering scheme 408 may be based on one or more similarity scores between each of the keyword embeddings of the keyword tokens and the token-level interaction description embeddings of an interaction description 404. In some examples, an ordering scheme 408 may be used in a prediction-based action 410. For example, in a case where a prediction-based action 410 is to apply a color gradient to keywords of a keywords list, the color gradient may be applied based on the ordering scheme 408 (e.g., the first 3 keyword tokens may correspond to a green color gradient, the next 3 keyword tokens may correspond to a yellow color gradient, etc.).

In some embodiments, a secondary interaction corpus is identified based on a code type of the interaction code 302 and, in response to identifying a secondary interaction corpus, a plurality of secondary candidate keyword tokens is extracted from the secondary interaction corpus. In some examples, a secondary keywords list is generated from the plurality of secondary candidate keyword tokens.

In some embodiments, a secondary interaction corpus is a collection or repository of information relevant to one or more interaction codes 302 that may supplement and/or supersede an interaction corpus for one or more interaction codes 302. In some examples, a secondary interaction corpus may be used to expand and/or replace the information provided by the interaction corpus. In some examples, one or more different secondary interaction corpuses may be leveraged to augment and/or replace keywords for one or more interaction codes 302 associated therewith. By way of example, a secondary interaction corpus, for a subset of interaction codes 302, may include one or more E&M checklists that respectively correspond to the subset of interaction codes 302.

In some embodiments, a secondary interaction corpus may be tailored to an evaluation, search, and/or other task for an interaction data object 402. For example, in some scenarios, an interaction data object 402 may be reviewed to ensure that one or more criteria are satisfied for an interaction code 302. In some examples, the one or more criteria may be illustrated by an E&M checklist, such that keywords generated from the E&M checklist may direct a user through the interaction data object 402 in accordance with the E&M checklist. In this way, a different set of keywords may be generated from number of data sources to curate keywords that are both predictive and recognizable to a user.

In some embodiments, a secondary candidate keyword token is a token of a candidate keyword associated with a secondary keywords list.

In some embodiments, a secondary keywords list is a keywords list sourced from a secondary interaction corpus. For example, a secondary interaction corpus may be used to generate a secondary keywords list to expand and/or replace information provided by a keywords list. For example, one or more secondary candidate keyword tokens may be identified from a secondary interaction corpus. The one or more secondary candidate keywords tokens may be filtered, pruned, expanded, and/or the like in accordance with one or more embodiments described herein. In some examples, one or more secondary candidate keywords tokens may be selected for a secondary keywords list based on one or more exact matches, one or more fuzzy matches, and/or one or more embedding similarity measures in accordance with one or more embodiments described herein. In some examples, a cross-token similarity score may be generated for each secondary candidate keyword token based on a comparison between a corresponding secondary token-level candidate keyword embedding and a plurality of token-level interaction description embeddings respectively corresponding to a plurality of description tokens from the interaction description 404. Secondary candidate keyword tokens corresponding to cross-token similarity scores that satisfy a similarity threshold (e.g., 0.9) and/or a limit threshold may be included in the keywords list. Additionally, or alternatively, a cross-token similarity score may be generated for an average embedding for one or more secondary candidate keyword tokens.

In some embodiments, an interaction-specific keywords list 406 may be surfaced to a user, via a user interface, to provide document insights for an interaction data object 402. For example, in a clinical context, an interaction-specific keywords list 406 may be used by a clinical expert in review of a medical record (e.g., interaction description of a data object). In some examples, an interaction-specific keywords list 406 may be used to perform one or more prediction-based actions. For example, a keywords list may be used to highlight terms, apply a color gradient to terms, and/or the like, that are identified based on the interaction-specific keywords list 406.

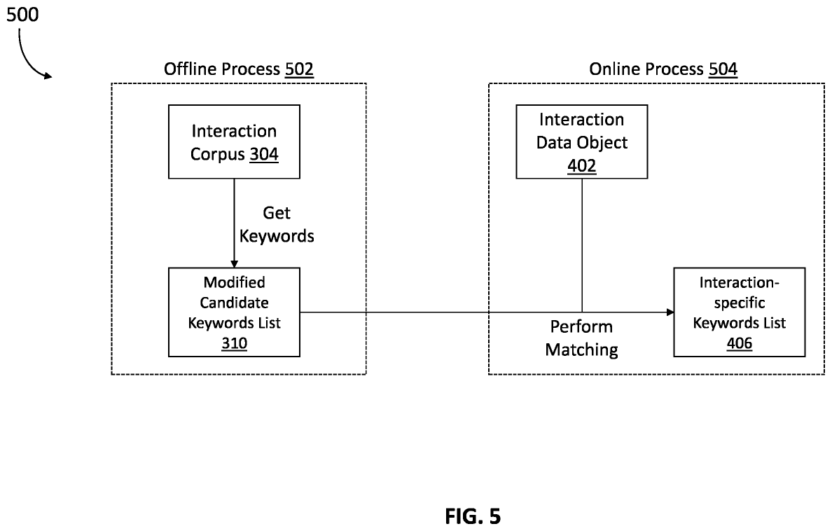

In some embodiments, one or more operations described with reference to FIG. 3 and/or FIG. 4 may be configured to execute in an offline process or an online process. By splitting operations described herein between offline and online processes, various embodiments of the present disclosure achieve efficient computational performance and reduce complexity at runtime compared with other undesirable solutions. An example offline process and online process for performing one or more operations described herein will now be further described with reference to FIG. 5.

FIG. 5 is an example asynchronous, multi-stage pipeline 500 for tailoring and surfacing keywords within a search domain in accordance with some embodiments discussed herein. The multi-stage pipeline 500 includes a complementary offline process 502 and online process 504. In some examples, the offline process 502 may be performed by a first computing entity and the online process 504 may be performed by a second computing entity. In some examples, the offline process 502 and online process 504 may be performed by the same computing entity. As described herein, the offline process 502 may be continuously performed asynchronously with the online process 504 to continuously generate, refine, and modify modified candidate keywords lists 310 for a search domain using an interaction corpus 304 (and/or secondary corpus, etc.) associated with the search domain. For instance, in some examples, the modified candidate keywords lists 310 may be modified responsive to one or modifications to the interaction corpus 304 (and/or secondary corpus, etc.). The modified candidate keywords lists 310 may be asynchronously leveraged during an online process 504 to generate an interaction-specific keywords list 406 for a particular retrieval task associated with an interaction data object 402.

In some embodiments, the offline process 502 includes extracting keywords from an interaction corpus 304 to generate the modified candidate keywords list 310. For example, an interaction code may be used in combination with the interaction corpus 304 to identify one or more interaction code descriptions. In some examples, the offline process 502 may be performed for each interaction code of an interaction corpus 304. In some examples, one or more interaction code descriptions related to an interaction code from the interaction corpus 304 may be aggregated to generate a candidate keywords list. The candidate keywords list may be modified by one or more operations (e.g., filtering, pruning, expanding, etc.) to generate the modified candidate keywords list 310. In some examples, an iteration of the offline process 502 may end with storing the modified candidate keywords list 310 for use by the complementary online process 504.

In some embodiments, the online process 504 leverages an interaction data object 402 to generate an interaction-specific keywords list 406 for a particular retrieval task. For example, an interaction data object 402 may be used to identify one or more interaction codes and an interaction description. In some examples, the interaction code may be used to identify one or more corresponding modified candidate keyword lists 310. In some examples, the one or more identified modified candidate keywords lists 310 may be received, for example, from a datastore that may be continuously populated by the asynchronous offline process 502. In some examples, the interaction code description may be used in one or more matching operations (e.g., embedding match, fuzzy match, exact match, etc.) with the received one or more modified candidate keywords lists 310 to generate an interaction-specific keywords list 406. In this way, the online process 504 may be performed at runtime to deliver real time or near real time results (e.g., the interaction-specific keywords list 406) based on a received interaction data object 402.

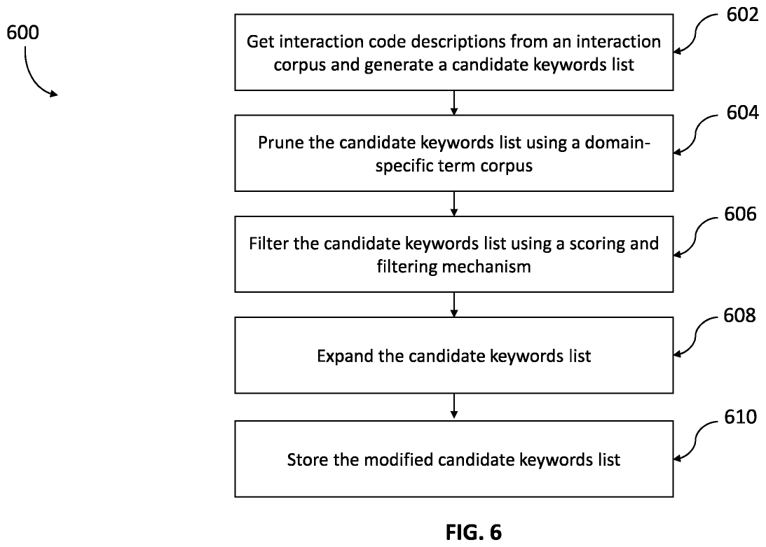

FIG. 6 is a flowchart showing an example process 600 for asynchronously generating modified candidate keywords lists that are tailored to a search domain in accordance with some embodiments discussed herein. The flowchart depicts an asynchronous offline process for generating keywords lists that are tailored to a particular search domain. The process 600 may be implemented by one or more computing devices, entities, and/or systems described herein. For example, via the various steps/operations of the process 600, the computing system 100 may leverage improved text generation and filtering techniques to generate and continuously refine a keyword list based on domain knowledge within a search domain. By doing so, the process 600 facilitates keyword generation techniques that are directly tailored to addressing technical challenges, such as interpretability, and/or the like, of traditional keyword generation techniques.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 includes, at step/operation 602, receiving interaction code descriptions from an interaction corpus and generating a candidate keywords list. For example, a computing system 100 may identify an interaction code from an interaction data object and receive a modified candidate keywords list for the interaction code, where the modified candidate keywords list is generated by iteratively appending one or more interaction code descriptions of an interaction corpus corresponding to the interaction code to generate a candidate keywords list.

In some embodiments, the process 600 includes, at step/operation 604, pruning the candidate keywords list using a domain-specific term corpus. For example, a computing system 100 may generate the modified candidate keywords list using a domain-specific term corpus by pruning one or more predefined terms of the domain-specific term corpus from the candidate keywords list.

In some embodiments, the process 600 includes, at step/operation 606, filtering the candidate keywords list using a scoring and filtering mechanism. For example, a computing system 100 may generate the candidate keywords list by identifying an initial interaction code description for the interaction code from an initial node within the interaction corpus that corresponds to the interaction code, identifying a plurality of subsequent hierarchical code descriptions for a plurality of subsequent interaction codes that respectively correspond to a plurality of subsequent nodes within the interaction corpus, and appending the initial interaction code description with the plurality of subsequent hierarchical code descriptions, where the plurality of subsequent nodes comprise a subset of a plurality of parent nodes of the initial node and the subset of parent nodes is based on a relevance threshold.

In some embodiments, the process 600 includes, at step/operation 608, expanding the candidate keywords list. For example, a computing system 100 may expand the modified candidate keywords list using the domain-specific machine learning embedding model by identifying one or more expansion tokens for the modified candidate keywords list based on a plurality of expansion token similarity scores between an initial subset of the plurality of token-level candidate keywords embeddings and a plurality of candidate expansion token embeddings corresponding to a plurality of candidate expansion tokens, an expansion similarity threshold, and an expansion threshold. The computing system 100 may append the one or more expansion tokens to the modified candidate keywords list.

In some embodiments, the process 600 includes, at step/operation 610, storing the modified candidate keywords list. For example, a computing system 100 may store the modified candidate keywords list in a datastore.

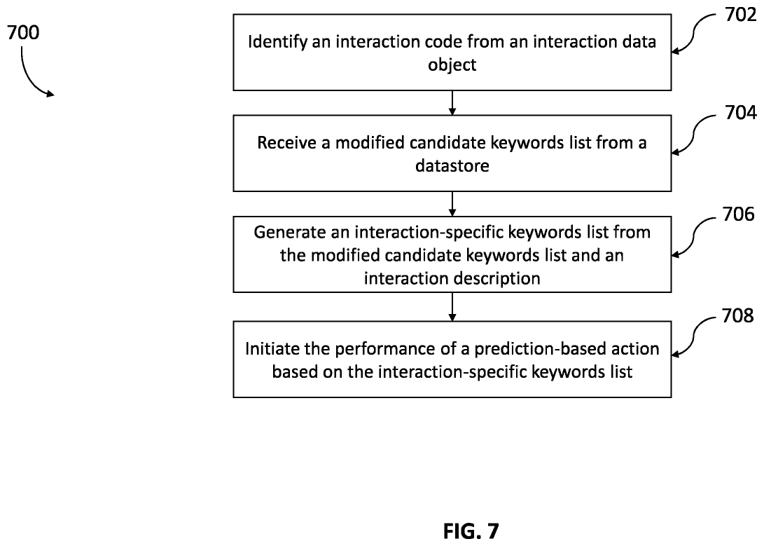

FIG. 7 is a flowchart showing an example process 700 for retrieving a modified candidate keywords list to generate an interaction-specific keywords list and initiate a prediction-based action based thereon in accordance with some embodiments discussed herein. The flowchart depicts a real time retrieval process for initiating a prediction-based action based on a keywords list tailored to a particular search domain. The process 700 may be implemented by one or more computing devices, entities, and/or systems described herein. For example, via the various steps/operations of the process 700, the computing system 100 may leverage improved matching techniques to generate an interaction-specific keywords list based on a retrieved modified candidate keywords list and a received interaction description. By doing so, the process 700 facilitates keyword identification techniques that are directly tailored to addressing technical challenges, such as interpretability, dynamic interface navigation, and/or the like, of traditional keyword generation techniques.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 includes, at step/operation 702, identifying an interaction code from an interaction data object. For example, a computing system 100 may identify an interaction code from an interaction data object.

In some embodiments, the process 700 includes, at step/operation 704, receiving a modified candidate keywords list from a datastore. For example, a computing system 100 may receive a modified candidate keywords list for an interaction code.

In some embodiments, the process 700 includes, at step/operation 706, generating an interaction-specific keywords list from the modified candidate keywords list and an interaction description. For example, a computing system 100 may generate an interaction-specific keywords list based on a comparison between a modified candidate keywords list and an interaction description of the interaction data object.

In some embodiments, the process 700 includes, at step/operation 708, initiating the performance of a prediction-based action based on the interaction-specific keywords list. For example, a computing system 100 may initiate the performance of a prediction-based action based on an interaction-specific keywords list.

Some techniques of the present disclosure enable the generation of action outputs that may be performed to initiate one or more prediction-based actions to achieve real-world effects. The keyword identification techniques of the present disclosure may be used, applied, and/or otherwise leveraged to generate, store, and retrieve a keywords list, which may help in the efficiency, reliability, and latency of computer-based keyword identification processes with respect to various prediction-based actions performed by the computing system 100. Example prediction-based actions may include modifying a textual description at a client device. For instance, the generated keywords list may be used to highlight and/or apply a color gradient to terms of the textual description. Modification of the textual description may be used to aid in a review process of the textual description for which a prediction-based action may be initiated to automatically address.

In some examples, the computing tasks may include actions that may be based on a search domain. A search domain may include any environment in which computing systems may be applied to achieve real-world insights, such as in a review process (e.g., clinical claims review), and initiate the performance of computing tasks, such as prediction-based actions to act on the real-world insights (e.g., keyword identification, keyword-based navigation, etc.). These actions may cause real-world changes, for example, by controlling a hardware component, providing alerts, interactive actions, and/or the like.

### VI. CONCLUSION

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising identifying, by one or more processors, an interaction code from an interaction data object; receiving, by the one or more processors, a modified candidate keywords list for the interaction code, wherein the modified candidate keywords list is generated by: iteratively appending one or more interaction code descriptions of an interaction corpus corresponding to the interaction code to generate a candidate keywords list, and generating, using a domain-specific term corpus, the modified candidate keywords list by pruning one or more predefined terms of the domain-specific term corpus from the candidate keywords list; generating, by the one or more processors, an interaction-specific keywords list based on a comparison between the modified candidate keywords list and an interaction description of the interaction data object; and initiating, by the one or more processors, the performance of a prediction-based action based on the interaction-specific keywords list.

Example 2. The computer-implemented method of example 1, wherein the prediction-based action comprises one or more of (i) highlighting terms in the interaction description based on the interaction-specific keywords list or (ii) applying a color gradient to terms in the interaction description based on the interaction-specific keywords list and an ordering scheme.

Example 3. The computer-implemented method of any of the above examples, wherein the interaction corpus comprises a hierarchical node structure and generating the candidate keywords list comprises: identifying an initial interaction code description for the interaction code from an initial node within the interaction corpus that corresponds to the interaction code; identifying a plurality of subsequent hierarchical code descriptions for a plurality of subsequent interaction codes that respectively correspond to a plurality of subsequent nodes within the interaction corpus; and appending the initial interaction code description with the of the plurality of subsequent hierarchical code descriptions.

Example 4. The computer-implemented method of example 3, wherein each of the plurality of subsequent nodes is a parent node of the initial node within the hierarchical node structure.

Example 5. The computer-implemented method of examples 3 or 4, wherein the plurality of subsequent nodes comprises a subset of a plurality of parent nodes of the initial node and the subset of parent nodes is based on a relevance threshold.

Example 6. The computer-implemented method of any of the above examples, wherein generating the interaction-specific keywords list comprises: generating, using a domain-specific machine learning embedding model, a plurality of token-level candidate keyword embeddings for a plurality of candidate tokens of the modified candidate keywords list; generating, using the domain-specific machine learning embedding model, a plurality of token-level interaction description embeddings for a plurality of description tokens of the interaction description; and generating the interaction-specific keywords list by selecting one or more candidate tokens from the plurality of candidate tokens based on a plurality of cross-token similarity scores between the plurality of token-level candidate keyword embeddings and the plurality of token-level interaction description embeddings.

Example 7. The computer-implemented method of example 6, wherein the one or more candidate tokens are based on (i) a comparison between the plurality of cross-token similarity scores and a similarity threshold and (ii) a limit threshold.

Example 8. The computer-implemented method of example 7, wherein the computer-implemented method further comprises expanding the modified candidate keywords list by: identifying, using the domain-specific machine learning embedding model, one or more expansion tokens for the modified candidate keywords list based on (i) a plurality of expansion token similarity scores between an initial subset of the plurality of token-level candidate keyword embeddings and a plurality of candidate expansion token embeddings corresponding to a plurality of candidate expansion tokens (ii) an expansion similarity threshold, and (iii) an expansion threshold; and appending the one or more expansion tokens to the modified candidate keywords list.

Example 9. The computer-implemented method of example 8, wherein the interaction corpus comprises a hierarchical node structure and the initial subset of the plurality of token-level candidate keyword embeddings correspond to a subset of the plurality of candidate tokens of the modified candidate keywords list that are associated with an initial layer of the hierarchical node structure.

Example 10. The computer-implemented method of example 6, wherein a cross-token similarity score of the plurality of cross-token similarity scores comprises a fuzzy matching score.

Example 11. The computer-implemented method of any of the above examples, further comprising: identifying a secondary interaction corpus based on a code type of the interaction code; in response to identifying the secondary interaction corpus, extracting a plurality of secondary candidate keyword tokens from the secondary interaction corpus; and generating a secondary keywords list from the plurality of secondary candidate keyword tokens.

Example 12. A computing system comprising memory and one or more processors communicatively coupled to the memory, the one or more processors configured to: identify, by one or more processors, an interaction code from an interaction data object; receive, by the one or more processors, a modified candidate keywords list for the interaction code, wherein the modified candidate keywords list is generated by: iteratively appending one or more interaction code descriptions of an interaction corpus corresponding to the interaction code to generate a candidate keywords list, and generating, using a domain-specific term corpus, the modified candidate keywords list by pruning one or more predefined terms of the domain-specific term corpus from the candidate keywords list; generate, by the one or more processors, an interaction-specific keywords list based on a comparison between the modified candidate keywords list and an interaction description of the interaction data object; and initiate, by the one or more processors, the performance of a prediction-based action based on the interaction-specific keywords list.

Example 13. The computing system of example 12, wherein the prediction-based action comprises one or more of (i) highlighting terms in the interaction description based on the interaction-specific keywords list or (ii) applying a color gradient to terms in the interaction description based on the interaction-specific keywords list and an ordering scheme.

Example 14. The computing system of examples 12 or 13, wherein the interaction corpus comprises a hierarchical node structure and generating the candidate keywords list comprises: identifying an initial interaction code description for the interaction code from an initial node within the interaction corpus that corresponds to the interaction code; identifying a plurality of subsequent hierarchical code descriptions for a plurality of subsequent interaction codes that respectively correspond to a plurality of subsequent nodes within the interaction corpus; and appending the initial interaction code description with the of the plurality of subsequent hierarchical code descriptions.

Example 15. The computing system of example 14, wherein each of the plurality of subsequent nodes is a parent node of the initial node within the hierarchical node structure.

Example 16. The computing system of example 14, wherein the plurality of subsequent nodes comprises a subset of a plurality of parent nodes of the initial node and the subset of parent nodes is based on a relevance threshold.

Example 17. The computing system of any of the examples 12 through 16, wherein generating the interaction-specific keywords list comprises: generating, using a domain-specific machine learning embedding model, a plurality of token-level candidate keyword embeddings for a plurality of candidate tokens of the modified candidate keywords list; generating, using the domain-specific machine learning embedding model, a plurality of token-level interaction description embeddings for a plurality of description tokens of the interaction description; and generating the interaction-specific keywords list by selecting one or more candidate tokens from the plurality of candidate tokens based on a plurality of cross-token similarity scores between the plurality of token-level candidate keyword embeddings and the plurality of token-level interaction description embeddings.

Example 18. The computing system of example 17, wherein the one or more candidate tokens are based on (i) a comparison between the plurality of cross-token similarity scores and a similarity threshold and (ii) a limit threshold.

Example 19. The computing system of example 17, wherein the one or more processors are further configured to expand the modified candidate keywords list by: identifying, using the domain-specific machine learning embedding model, one or more expansion tokens for the modified candidate keywords list based on (i) a plurality of expansion token similarity scores between an initial subset of the plurality of token-level candidate keyword embeddings and a plurality of candidate expansion token embeddings corresponding to a plurality of candidate expansion tokens (ii) an expansion similarity threshold, and (iii) an expansion threshold; and appending the one or more expansion tokens to the modified candidate keywords list.

Example 20. One or more non-transitory computer-readable storage media including instructions that, when executed by one or more processors, cause the one or more processors to: identify, by one or more processors, an interaction code from an interaction data object; receive, by the one or more processors, a modified candidate keywords list for the interaction code, wherein the modified candidate keywords list is generated by: iteratively appending one or more interaction code descriptions of an interaction corpus corresponding to the interaction code to generate a candidate keywords list, and generating, using a domain-specific term corpus, the modified candidate keywords list by pruning one or more predefined terms of the domain-specific term corpus from the candidate keywords list; generate, by the one or more processors, an interaction-specific keywords list based on a comparison between the modified candidate keywords list and an interaction description of the interaction data object; and initiate, by the one or more processors, the performance of a prediction-based action based on the interaction-specific keywords list.

Example 21. The computer-implemented method of example 1, wherein the method further comprises training the domain-specific machine learning embedding model.

Example 22. The computer-implemented method of example 21, wherein the training is performed by the one or more processors.

Example 23. The computer-implemented method of example 21, wherein the one or more processors are included in a first computing entity; and the training is performed by one or more other processors included in a second computing entity.

Example 24. The computing system of example 11, wherein the one or more processors are further configured to train the domain-specific machine learning embedding model, the machine learning embedding model, and the LLM.

Example 25. The computing system of example 24, wherein the one or more processors are included in a first computing entity; and the domain-specific machine learning embedding model is trained by one or more other processors included in a second computing entity.

Example 26. The one or more non-transitory computer-readable storage media of example 18, wherein the instructions further cause the one or more processors to train the domain-specific machine learning embedding model.

Example 27. The one or more non-transitory computer-readable storage media of example 26, wherein the one or more processors are included in a first computing entity; and the domain-specific machine learning embedding model are trained by one or more other processors included in a second computing entity.

1. A computer-implemented method comprising:
identifying, by one or more processors, an interaction code from an interaction data object;
receiving, by the one or more processors, a modified candidate keywords list for the interaction code, wherein the modified candidate keywords list is generated by:
iteratively appending one or more interaction code descriptions of an interaction corpus corresponding to the interaction code to generate a candidate keywords list, and
generating, using a domain-specific term corpus, the modified candidate keywords list by pruning one or more predefined terms of the domain-specific term corpus from the candidate keywords list;
generating, by the one or more processors, an interaction-specific keywords list based on a comparison between the modified candidate keywords list and an interaction description of the interaction data object; and
initiating, by the one or more processors, the performance of a prediction-based action based on the interaction-specific keywords list.

2. The computer-implemented method of claim 1, wherein the prediction-based action comprises one or more of (i) highlighting terms in the interaction description based on the interaction-specific keywords list or (ii) applying a color gradient to terms in the interaction description based on the interaction-specific keywords list and an ordering scheme.

3. The computer-implemented method of claim 1, wherein the interaction corpus comprises a hierarchical node structure and generating the candidate keywords list comprises:
identifying an initial interaction code description for the interaction code from an initial node within the interaction corpus that corresponds to the interaction code;
identifying a plurality of subsequent hierarchical code descriptions for a plurality of subsequent interaction codes that respectively correspond to a plurality of subsequent nodes within the interaction corpus; and
appending the initial interaction code description with the of the plurality of subsequent hierarchical code descriptions.

4. The computer-implemented method of claim 3, wherein each of the plurality of subsequent nodes is a parent node of the initial node within the hierarchical node structure.

5. The computer-implemented method of claim 3, wherein the plurality of subsequent nodes comprises a subset of a plurality of parent nodes of the initial node and the subset of parent nodes is based on a relevance threshold.

6. The computer-implemented method of claim 1, wherein generating the interaction-specific keywords list comprises:
generating, using a domain-specific machine learning embedding model, a plurality of token-level candidate keyword embeddings for a plurality of candidate tokens of the modified candidate keywords list;
generating, using the domain-specific machine learning embedding model, a plurality of token-level interaction description embeddings for a plurality of description tokens of the interaction description; and
generating the interaction-specific keywords list by selecting one or more candidate tokens from the plurality of candidate tokens based on a plurality of cross-token similarity scores between the plurality of token-level candidate keyword embeddings and the plurality of token-level interaction description embeddings.

7. The computer-implemented method of claim 6, wherein the one or more candidate tokens are based on (i) a comparison between the plurality of cross-token similarity scores and a similarity threshold and (ii) a limit threshold.

8. The computer-implemented method of claim 7, wherein the computer-implemented method further comprises expanding the modified candidate keywords list by:
identifying, using the domain-specific machine learning embedding model, one or more expansion tokens for the modified candidate keywords list based on (i) a plurality of expansion token similarity scores between an initial subset of the plurality of token-level candidate keyword embeddings and a plurality of candidate expansion token embeddings corresponding to a plurality of candidate expansion tokens (ii) an expansion similarity threshold, and (iii) an expansion threshold; and
appending the one or more expansion tokens to the modified candidate keywords list.

9. The computer-implemented method of claim 8, wherein the interaction corpus comprises a hierarchical node structure and the initial subset of the plurality of token-level candidate keyword embeddings correspond to a subset of the plurality of candidate tokens of the modified candidate keywords list that are associated with an initial layer of the hierarchical node structure.

10. The computer-implemented method of claim 6, wherein a cross-token similarity score of the plurality of cross-token similarity scores comprises a fuzzy matching score.

11. The computer-implemented method of claim 1, further comprising:
identifying a secondary interaction corpus based on a code type of the interaction code;
in response to identifying the secondary interaction corpus, extracting a plurality of secondary candidate keyword tokens from the secondary interaction corpus; and
generating a secondary keywords list from the plurality of secondary candidate keyword tokens.

12. A computing system comprising memory and one or more processors communicatively coupled to the memory, the one or more processors configured to:
identify, by one or more processors, an interaction code from an interaction data object;
receive, by the one or more processors, a modified candidate keywords list for the interaction code, wherein the modified candidate keywords list is generated by:
iteratively appending one or more interaction code descriptions of an interaction corpus corresponding to the interaction code to generate a candidate keywords list, and
generating, using a domain-specific term corpus, the modified candidate keywords list by pruning one or more predefined terms of the domain-specific term corpus from the candidate keywords list;
generate, by the one or more processors, an interaction-specific keywords list based on a comparison between the modified candidate keywords list and an interaction description of the interaction data object; and
initiate, by the one or more processors, the performance of a prediction-based action based on the interaction-specific keywords list.

13. The computing system of claim 12, wherein the prediction-based action comprises one or more of (i) highlighting terms in the interaction description based on the interaction-specific keywords list or (ii) applying a color gradient to terms in the interaction description based on the interaction-specific keywords list and an ordering scheme.

14. The computing system of claim 12, wherein the interaction corpus comprises a hierarchical node structure and generating the candidate keywords list comprises:
identifying an initial interaction code description for the interaction code from an initial node within the interaction corpus that corresponds to the interaction code;
identifying a plurality of subsequent hierarchical code descriptions for a plurality of subsequent interaction codes that respectively correspond to a plurality of subsequent nodes within the interaction corpus; and
appending the initial interaction code description with the of the plurality of subsequent hierarchical code descriptions.

15. The computing system of claim 14, wherein each of the plurality of subsequent nodes is a parent node of the initial node within the hierarchical node structure.

16. The computing system of claim 14, wherein the plurality of subsequent nodes comprises a subset of a plurality of parent nodes of the initial node and the subset of parent nodes is based on a relevance threshold.

17. The computing system of claim 12, wherein generating the interaction-specific keywords list comprises:
generating, using a domain-specific machine learning embedding model, a plurality of token-level candidate keyword embeddings for a plurality of candidate tokens of the modified candidate keywords list;
generating, using the domain-specific machine learning embedding model, a plurality of token-level interaction description embeddings for a plurality of description tokens of the interaction description; and
generating the interaction-specific keywords list by selecting one or more candidate tokens from the plurality of candidate tokens based on a plurality of cross-token similarity scores between the plurality of token-level candidate keyword embeddings and the plurality of token-level interaction description embeddings.

18. The computing system of claim 17, wherein the one or more candidate tokens are based on (i) a comparison between the plurality of cross-token similarity scores and a similarity threshold and (ii) a limit threshold.

19. The computing system of claim 17, wherein the one or more processors are further configured to expand the modified candidate keywords list by:
identifying, using the domain-specific machine learning embedding model, one or more expansion tokens for the modified candidate keywords list based on (i) a plurality of expansion token similarity scores between an initial subset of the plurality of token-level candidate keyword embeddings and a plurality of candidate expansion token embeddings corresponding to a plurality of candidate expansion tokens (ii) an expansion similarity threshold, and (iii) an expansion threshold; and
appending the one or more expansion tokens to the modified candidate keywords list.

20. One or more non-transitory computer-readable storage media including instructions that, when executed by one or more processors, cause the one or more processors to:
identify, by one or more processors, an interaction code from an interaction data object;
receive, by the one or more processors, a modified candidate keywords list for the interaction code, wherein the modified candidate keywords list is generated by:
iteratively appending one or more interaction code descriptions of an interaction corpus corresponding to the interaction code to generate a candidate keywords list, and
generating, using a domain-specific term corpus, the modified candidate keywords list by pruning one or more predefined terms of the domain-specific term corpus from the candidate keywords list;
generate, by the one or more processors, an interaction-specific keywords list based on a comparison between the modified candidate keywords list and an interaction description of the interaction data object; and
initiate, by the one or more processors, the performance of a prediction-based action based on the interaction-specific keywords list.
